(19) United States
(12) Patent Application Publication
(10) Pub. No.: US 2010/0243406 A1
(43) Pub. Date: Sep. 30, 2010

(54) TRANSFER APPARATUS, TRANSPORT SYSTEM AND METHOD FOR HANDLING PARATS CARRIERS

(75) Inventor: Christian Mersnik, Attnang-Puchheim (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: STIWA Holding GmbH, Attnang-Puchheim (AT)

(21) Appl. No.: 12/310,238

(22) PCT Filed: Aug. 1, 2007
(86) PCT No.: PCT/AT2007/000372

§ 371 Date: Oct. 30, 2009

(30) Foreign Application Priority Data
Aug. 14, 2006 (AT) A 1359/2006

(51) Int. Cl. B65G 47/80; B65G 47/64

(52) U.S. Cl. 198/412; 198/476.1

(57) ABSTRACT

The invention describes a turntable (10) with a transfer means (17) for guiding and transmitting a driving force to a parts carrier (1) which can be displaced along guide tracks between a first conveying section (15) and a second conveying section (16) (5), and the transfer means (17) can be pivoted about a pivot axis (19) oriented perpendicular to a transport plane (20). The parts carrier (2) is provided with guide elements (7) by means of which the parts carrier (2) is guided along the guide tracks (5) and the transfer means (17) has a guide track along which the parts carrier (2) is guided by one of the guide elements (7). The invention further relates to a transport system (1) and a method of handling parts carriers (2) by means of a transfer apparatus (14) incorporating the described turntable (10).

The invention relates to a turntable with a transfer means for guiding and transmitting a driving force to a parts carrier which can be displaced along guide tracks between a first conveying section and a second conveying section, and the transfer means can be pivoted about a pivot axis oriented perpendicular to transport plane.

The invention further relates to a transfer apparatus with a feeding device comprising at least one turntable for guiding and transmitting a driving force to a parts carrier which can be displaced along guide tracks between a first conveying section and a second conveying section, and the turntable can be pivoted about a pivot axis oriented perpendicular to a transport plane.

The invention further relates to a transport system with a first conveying section and a second conveying section and a transfer apparatus disposed in between them.

The invention further relates to a method of handling parts carriers with a transfer apparatus and a feeding device comprising at least one turntable for guiding and transmitting a driving force to a parts carrier which can be displaced along guide tracks between a first conveying section and a second conveying section, and the turntable can be pivoted about a pivot axis oriented perpendicular to a transport plane, and to a method of controlling a transfer apparatus, in particular a transfer apparatus as defined in one of claims 11 to 36, for a parts carrier as well as a data carrier.

In automatic transport or conveyor systems used for manufacturing, processing or measuring processes, parts carriers loaded with workpieces are directed along conveyors. To enable the parts carriers with the workpieces to be moved to processing machines, handling stations or measuring stations or to adapt the conveyor to the conditions in situ and set up a closed circulation of the conveyor system, transfer apparatus is used which is able to divert and/or branch off the parts carriers.

patent specification WO 92/04259 discloses a device for diverting a workpiece carrier from one conveyor to another conveyor disposed at an angle to it in the same plane. Disposed between the two conveyors in the conveying direction is a rotating turntable, and the workpiece carrier is transported by the turntable by means of the frictional force acting between the two. The turntable is disposed in the inner conveyor region of the two conveyors. A lateral guide for the workpiece carrier is provided in the region of the outer curved track.

Another diverter station is known from document DE 26 44 137, comprising a rotating circular table with orifices. The orifices engage with driver pins of workpiece carriers and move them into a new position as they are partially guided by the conveyor side walls.

The underlying objective of this invention is to transport and divert objects conveyed along conveying sections rapidly, precisely and inexpensively.

This objective is achieved by the invention due to the fact that the parts carrier is provided with guide elements, by means of which the parts carrier is guided along the guide tracks, and the transfer means has at least one guide track, along which the parts carrier is positively guided by at least one of the guide elements, due to the fact that the turntable is based on a design as defined in one of claims 1 to 10, due to the fact that the transfer apparatus is based on a design as defined in one of claims 11 to 36, and due to a method whereby a first guide track is moved into a pick-up position, a first guide element of the parts carrier is picked up, the parts carrier is conveyed by means of a feeding device, in particular by means of a traction drive, a first guide track and/or another guide track is rotated into a pick-up position for picking up a second guide element of the parts carrier, the first guide track or second guide track is rotated as far as a transfer position, the parts carrier is conveyed by means of the feeding device to the transfer apparatus, in particular the transfer apparatus as defined in one of claims 11 to 36, and due to a method whereby control data is emitted in order to rotate a turntable into a pick-up position in which a guide element is transferred from a stationary guide track to at least one guide track of the turntable, and due to the fact that a programme for implementing a method as defined in one of claims 40 to 48 and/or a method as defined in one of claims 49 to 53 is stored on the data carrier.

Since the parts carrier is provided with guide elements by means of which the parts carrier is guided along the guide tracks and the transfer means has at least one guide track along which the parts carrier is positively guided by means of at least one of the guide elements, an effect can be achieved whereby the parts carrier is guided precisely and predictably. This results in a saving on costs because the parts carrier does not require any additional components to enable a positive guiding action and transmit a diving motion to the parts carrier.

In another embodiment of the turntable, the guide track of the transfer means extends in a straight line. This enables the use of standardised guide track elements and saves on manufacturing costs.

Another advantageous embodiment is one where the transfer means has a second guide track disposed at an angle with respect to the first one, and different guide elements of a parts carrier can each be guided in a specific way enabling the turntable to be better adapted to the motion sequence of the parts carrier.

Also of advantage is another embodiment in which the transfer means has a third guide track disposed at a distance from at least one diameter of one of the guide elements parallel with the first guide track or second guide track. As a result, a guide element can be guided by the transfer means virtually free of clearance at two oppositely lying sides. A more precise guiding action is achieved and the parts carrier is prevented from moving out of line.

In another embodiment, a distance of one end of the first guide track of the transfer means from one end of the second and/or third guide track or from a second end of the first guide track is shorter, than a distance between two guide elements of the parts carrier, in particular by at least the diameter of one of the guide elements, which means that the turntable can be pivoted when the parts carrier is in a position in which the turntable is disposed between two guide elements of the parts carrier. For example, during a guiding operation, a first guide element can be guided by a first guide track of the turntable and the turntable can be pivoted once the first guide track has left the turntable again so that another guide track of the turntable can use another guide element of the parts carrier for guiding purposes or to transmit a driving force. This enables a specifically adapted, optional guide track to be used for every guide element.

Based on another variant in which the guide track extends in a curved arrangement and the contour of the guide track has a curvature which increases monotonously or decreases monotonously the greater the distance of the guide track from the pivot axis, it may be of advantage if the speed curve of the parts carrier can be kept uniform, in particular constant, resulting in a constant pivoting movement of the turntable.

In another variant, one of the guide tracks of the transfer means is mounted so that it can be displaced relative to another guide track of the transfer means. This makes for better adaptation in a handover region in which a guide element is picked up or put down by the displaceably mounted guide track, and results in a better guiding action and handling option.

Based on another variant, at least one approximately V-shaped or U-shaped guide track arrangement, in particular guide tracks disposed more or less in a V-shape or U-shape, is disposed on the turntable so that it can be moved, or the approximately V-shaped or U-shaped guide track arrangement, in particular the guide tracks disposed more or less in a V-shape or U-shape, is mounted so as to be resiliently elastic and/or impart damping in at least one direction, the advantage of which is that a guide element of the parts carrier and hence the parts carrier itself can be guided more precisely and any guide clearance which might exist between the guide track and guide element can be minimised.

It may be of advantage if a transfer apparatus incorporates the turntable as defined in one of claims 1 to 10 because this enables the costs of a transfer apparatus or parts carriers used for a transfer apparatus of this type to be significantly reduced since the guide elements used to provide the guiding action are used to divert the parts carrier.

In one possible embodiment of a transfer apparatus, the guide tracks are provided as a means of guiding the guide elements of the parts carrier along guide lines and/or for guiding a central point of the parts carrier along a displacement track, and stationary guide tracks are disposed parallel with the transport plane relative to the turntable for guiding the parts carrier. This permits a pre-defined and uniform movement of the parts carrier.

In the case of another embodiment in which at least one guide track is disposed on the turntable, designed to guide a guide element of the parts carrier along an imaginary guide line when the turntable is stopped, the guide element can be transferred without having to turn the turntable. This makes it quicker and less complicated to guide and transmit a driving force to the parts carrier. It also prevents flexing of the parts carrier and the parts carrier is guided along a defined displacement path.

In one embodiment, at least one guide track is disposed on the turntable, which subtends an angle with an instantaneous direction of movement of the guide element when co-operating with a guide element of the parts carrier, and a drive device is connected to the turntable, which means that a driving force can be transmitted from the turntable to a guide element of the parts carrier and hence to the parts carrier.

In another advantageous embodiment, the drive device is provided in the form of an electrically operated motor, in particular a servo-motor. This offers an easy way of controlling the turntable and enables a standardised drive device to be used.

Based on another embodiment where the drive device is designed to position the turntable at specific angles, the parts carrier can be guided into an exact, pre-defined position or can be positioned and fixed in a pre-defined position.

Based on another embodiment where the feeding device comprises a traction drive, in particular a toothed belt drive, the parts carrier can be moved to the turntable.

An embodiment in which the turntable is mechanically connected to the traction drive dispenses with the need for a drive device, thereby reducing costs.

Multifunctional and more individual control options can be achieved using another embodiment in which a drive device for the traction drive provided separately from the drive device of the turntable is connected to the traction drive.

Another possible embodiment is one in which the parts carrier can be moved by means of the turntable from a pick-up position into a transfer position, in which case there is one method step during which the parts carrier, in the pick-up position or in the transfer position, moves between the guide tracks disposed so that they are not able to move relative to the transfer apparatus and the guide tracks co-operating with the turntable disposed so that they are able to move, and another possible method step during which, as the parts carrier is being moved between the pick-up position and transfer position, the parts carrier is moved by means of at least one of the guide tracks co-operating with the turntable. This enables the parts carrier to be positioned or transferred between a pick-up position in which a guide element of the parts carrier is transferred from a stationary guide track to the guide tracks of the turntable into a transfer position from which a guide element of the parts carrier is transferred from the guide tracks of the turntable to a stationary guide track of the transfer apparatus.

In another embodiment, the disposition of the turntable and/or the guide tracks enables the position of the parts carrier to be moved in the transport plane between the pick-up position and the transfer position due to the position of the turntable. As a result, the parts carrier can be moved to a desired position and retained in this position. This enables workpieces disposed on the parts carrier to be processed by processing machines, for example.

Also of advantage is another embodiment, in which the pivot axis of the turntable lies on an angle of symmetry between two straight guide lines or the displacement path and approximately perpendicular to them. This results in a simple disposition of the turntable on the transfer apparatus and thus offers a simpler sequence for the transfer of the parts carrier.

In another embodiment, the pivot axis of the turntable, in particular a turntable with a guide track extending in a curve, is disposed between two parallel, stationary guide tracks. Due to the fact that the turntable is disposed inside the guide tracks, a more compact design can be achieved.

Based on another option, the pivot axis of the turntable, in particular a turntable with a guide track running in a straight line, is disposed outside of two parallel guide tracks. As a result, the region between the guide tracks can be kept free for other feeding devices or processing devices or sensor systems.

As a result of other possible embodiments in which an approximately flat surface is disposed between the parallel guide tracks or in which the guide tracks are disposed above the surface at a height of at most 5 mm, risk of injury to a user can be minimised, especially a risk of injury due to crushing of the user's hands.

In other variants, in a region where one of the guide elements is transferred from a stationary guide track to a guide track of the turntable or where one of the guide elements is transferred from a guide track of the turntable to the stationary guide track, two parallel guide tracks are provided, in particular for one of the guide elements, and two parallel guide tracks are provided in a region of a guide line curve for one of the guide elements, in particular an inner guide track curve and/or an outer guide track curve, and in one variant of a method, at least one of the guide elements of the parts carrier is guided on two sides in directions perpendicular to the guide track and parallel with the transport plane, at least in a region where one of the guide elements is transferred from a stationary guide track to a guide track of the turntable or where one of the guide elements is transferred from a guide track of the turntable to the stationary guide track. This enables the guide elements of the parts carrier to be guided more precisely, preventing the parts carrier from being incorrectly directed and preventing the parts carrier from moving out of line.

In the case of another embodiment, a guide track of a guide track curve is formed by a curve, the radius of which is bigger at the curve beginning and/or curve end than in a section lying between the curve beginning and curve end, as a result of which the acceleration forces acting on the parts carrier when it is being diverted can be increased or decreased continuously. This effect is of particular advantage if the parts carrier is conveying containers with liquids which could spill due to a sudden rise in centrifugal forces due to wave impact.

In another embodiment, a radius of the guide line is bigger than half the diameter of the guide element. This enables the parts carrier to be continuously guided and prevents a sudden change in the direction of movement.

Other possible embodiments are ones where the feeding device comprises another turntable based on one of claims 1 to 10 and the feeding device has at least two other turntables based on one of claims 1 to 10. This offers extra options for manipulating the parts carrier. For example, a parts carrier can be branched off to another conveying section and/or the orientation of a parts carrier can be changed.

Based on another variant, a region across which at least one of the guide tracks of the turntable is able to pass forms a movement region and at least one branch of the guide line may lie within the movement region of the guide tracks of the turntable for changing orientation and/or changing the direction of movement, thereby enabling the parts carrier to be precisely and exactly guided by the turntable and the guide tracks disposed on it.

In one embodiment where the turntable and/or guide tracks are disposed so that a branch of the displacement path for changing orientation lies before a branch for changing the direction of movement of the parts carrier as viewed in the direction of movement, a simple mounting of the feeding device can be achieved.

Embodiments where the transfer apparatus is based on one of claims 11 to 36 and another conveying section is provided on the transfer apparatus or where another transfer apparatus is disposed on the transfer apparatus are of advantage because this results in an inexpensive transport system which can be readily adapted.

It is also of advantage to opt for a method whereby the work steps involve moving a first guide track into a pick-up position, picking up a first guide element of the parts carrier, conveying the parts carrier by means of a feeding device, in particular by means of a traction drive, rotating the first guide track and/or another guide track into a pick-up position in order to pick up a second guide element of the parts carrier, rotating the first guide track or second guide track to a transfer position, and conveying the parts carrier by means of the feeding device to the transfer apparatus, in particular the transfer apparatus based on one of claims 11 to 36. This permits an efficient transfer of a parts carrier from a first conveying section to another conveying section.

Another advantageous approach is one where the turntable is pivoted about the pivot axis of the turntable at a constant pivot speed. This offers a simple way of controlling the drive device of the turntable and enables the use of less expensive drive devices.

In another possible method, the turntable is moved on the basis of a speed curve enabling the parts carrier to be moved at a uniform, in particular constant, speed. Adapting the speed of the turntable in this manner means that the parts carrier moves uniformly and accelerations affecting the parts carrier can be kept to a minimum as far as possible.

Also of advantage is another variant of the method whereby the direction of movement of the parts carrier is changed by means of the transfer apparatus, in particular by 90°. As a result, the parts carrier can be diverted or branched off from a straight guide section.

In another variant of the method, the orientation or position of the parts carrier is changed by means of the transfer apparatus, in particular by 90° or 180°, and before and/or after changing the direction of movement, the orientation or position of the parts carrier is changed by the transfer apparatus, in particular by 90° or 180°. As a result, the orientation or position can be adapted in order to adapt the position of workpieces disposed on the parts carrier to other processing steps.

In one method of controlling a transfer apparatus where control data is transmitted to prompt the rotation of a turntable into a pick-up position in which a guide element is transferred from a stationary guide track to at least one guide track of the turntable, a guide element can be picked up by the guide tracks of the turntable in a controlled manner.

Also of advantage is another possible method step whereby control data is transmitted in order to rotate the turntable into a transfer position. The parts carrier cam therefore be moved in a controlled and specific manner.

In another approach, the control data for controlling several turntables disposed on a transfer apparatus can be synchronised by means of a synchronisation table. This obviates the need for complex calculations and enables the use of a less expensive computer unit.

Based on another approach, before and/or during and/or after conveying the parts carrier by means of the turntable, a signal is read in from a sensor and the control data is compiled as a function of a measured position of at least one turntable and/or a disposition and/or position of the parts carrier. This enables the position of the parts carrier to be controlled exactly and an alarm can be issued in the event of a fault or the fault eliminated.

The advantage of using a data carrier on which a programme for implementing a method as defined in one of claims 40 to 48 and/or a method as defined in one of claims 49 to 53 is stored is that the method can be readily implemented by a control device and transferred to other transport systems if necessary.

The invention will be explained in more detail below on the basis of examples of embodiments illustrated in the appended drawings.

Of these:

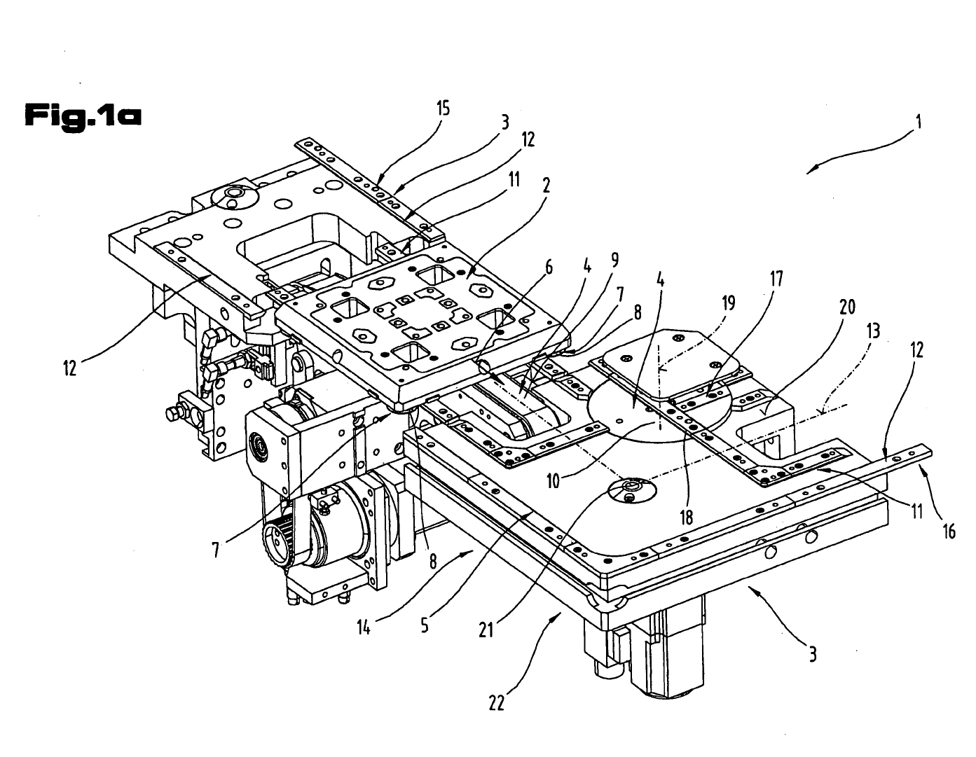

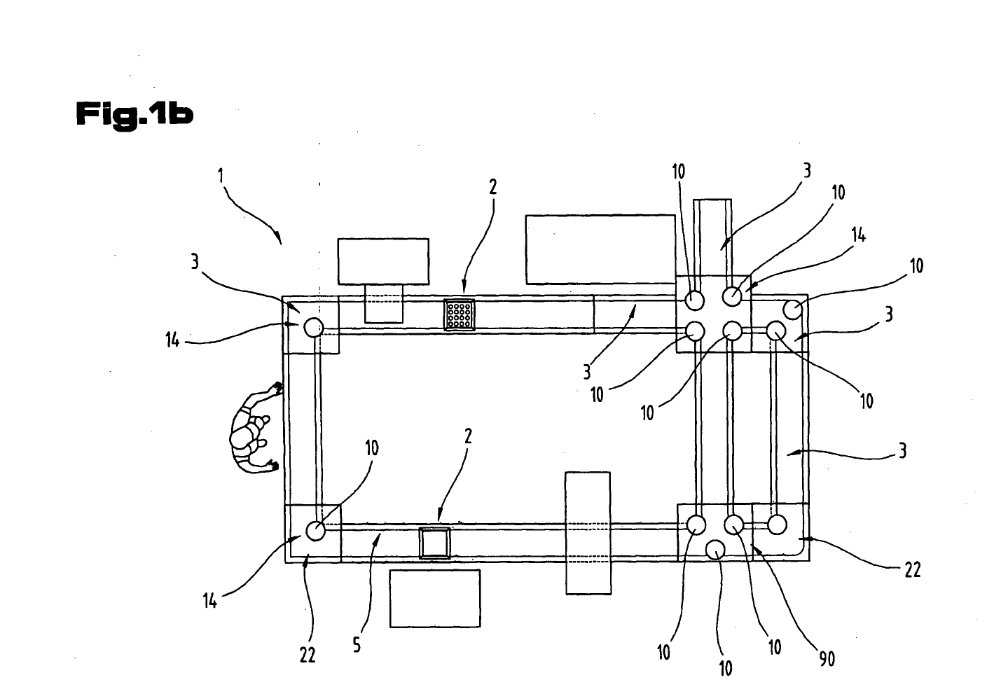

FIG. 1a is a perspective view of a part-section of a transport system;

FIG. 1b illustrates a transport system with work stations disposed along the transport system;

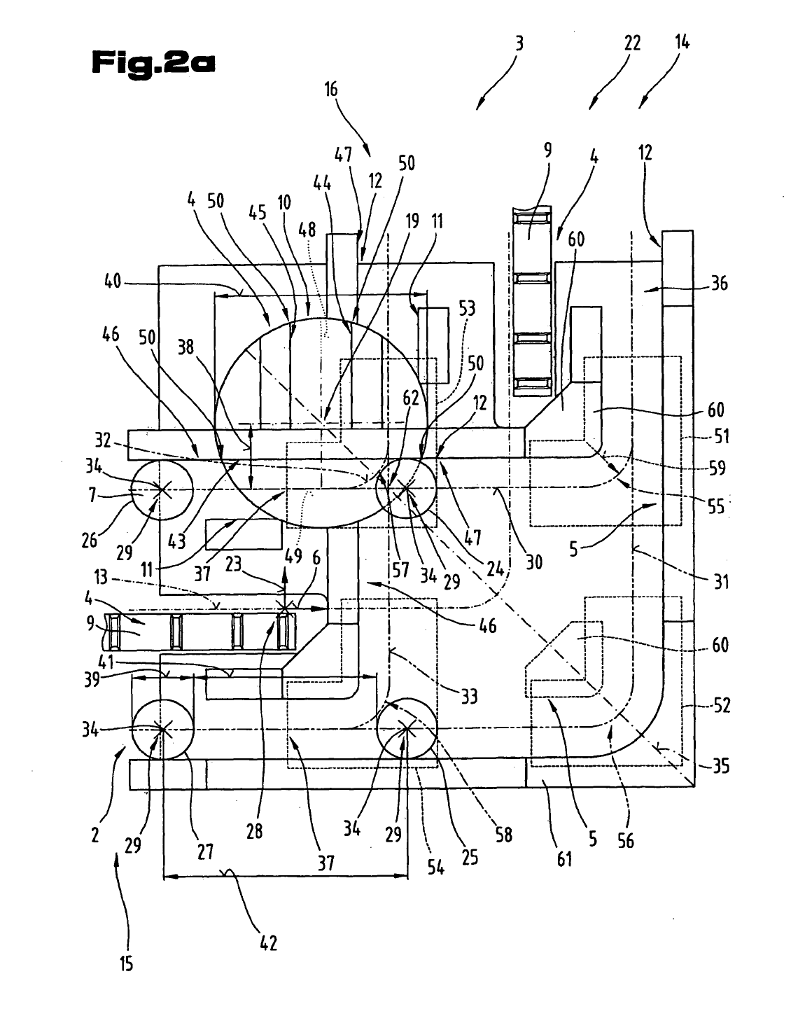

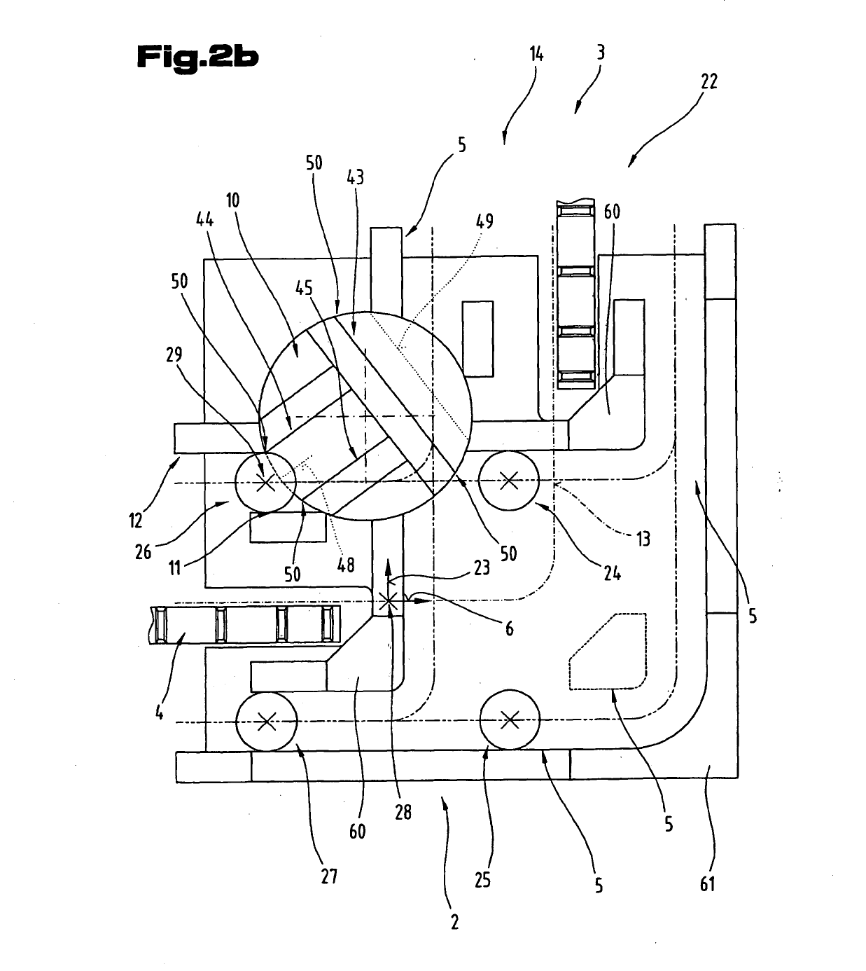

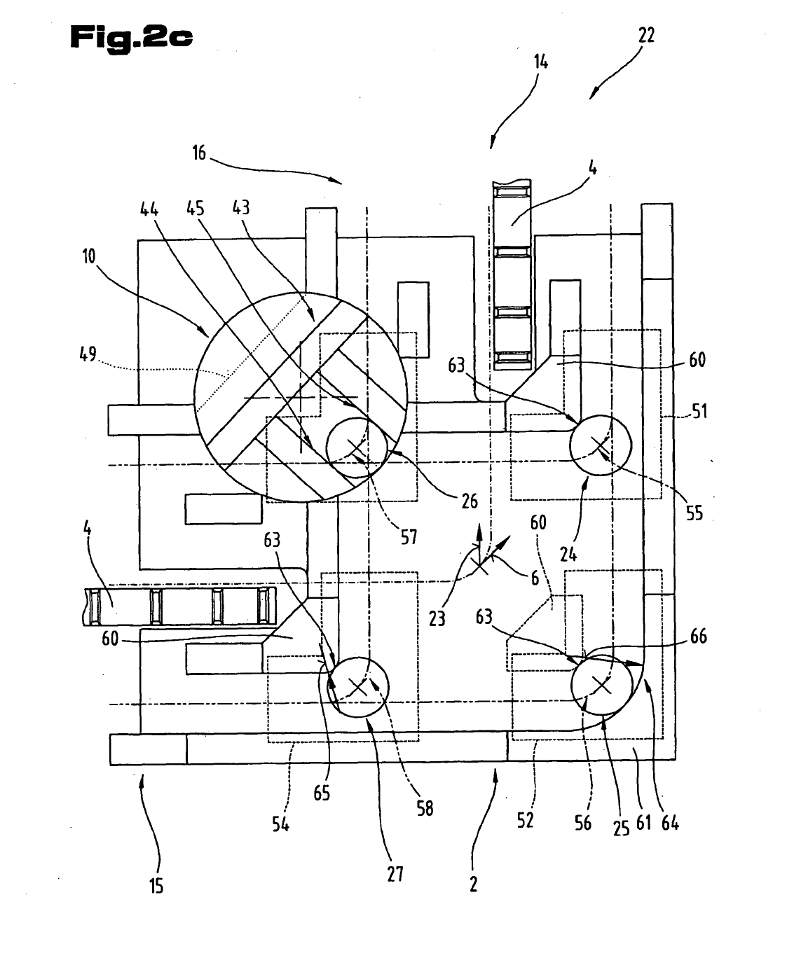

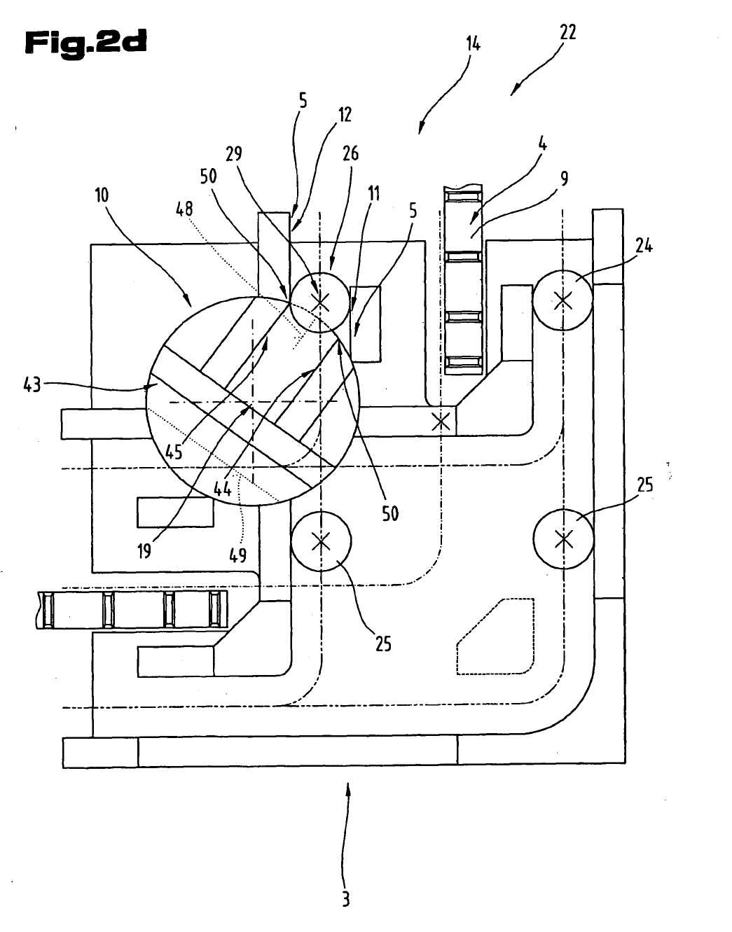

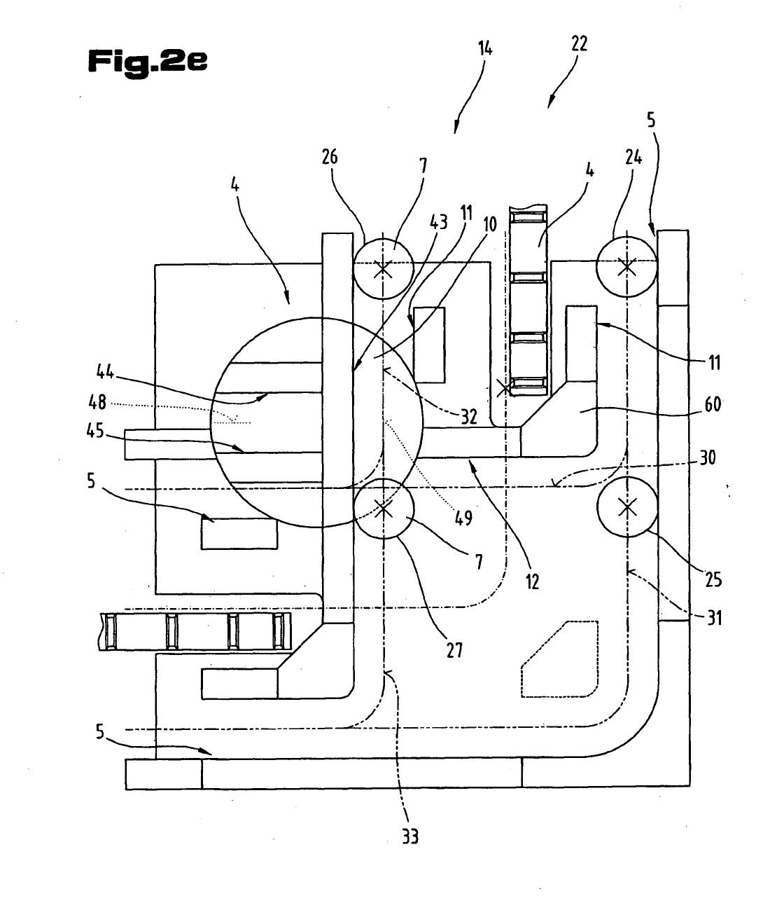

FIG. 2a is a schematic diagram of a transfer apparatus with a turntable and guide elements of a parts carrier in a transfer position;

FIG. 2b is a schematic diagram of a transfer apparatus with a turntable and guide elements of a parts carrier in a pick-up position;

FIG. 2c is a schematic diagram of a transfer apparatus with a turntable and guide elements of a parts carrier;

FIG. 2d is a schematic diagram of a transfer apparatus with a turntable and guide elements of a parts carrier in a transfer position;

FIG. 2e is a schematic diagram of a transfer apparatus with a turntable and guide elements of a parts carrier in a transfer position;

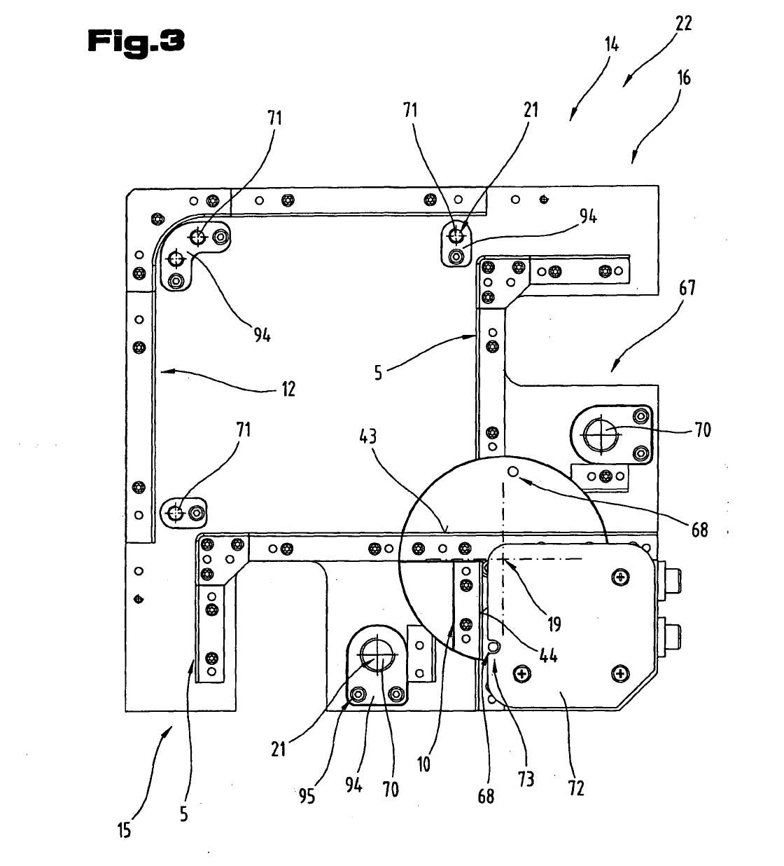

FIG. 3 is a plan view of a transfer apparatus;

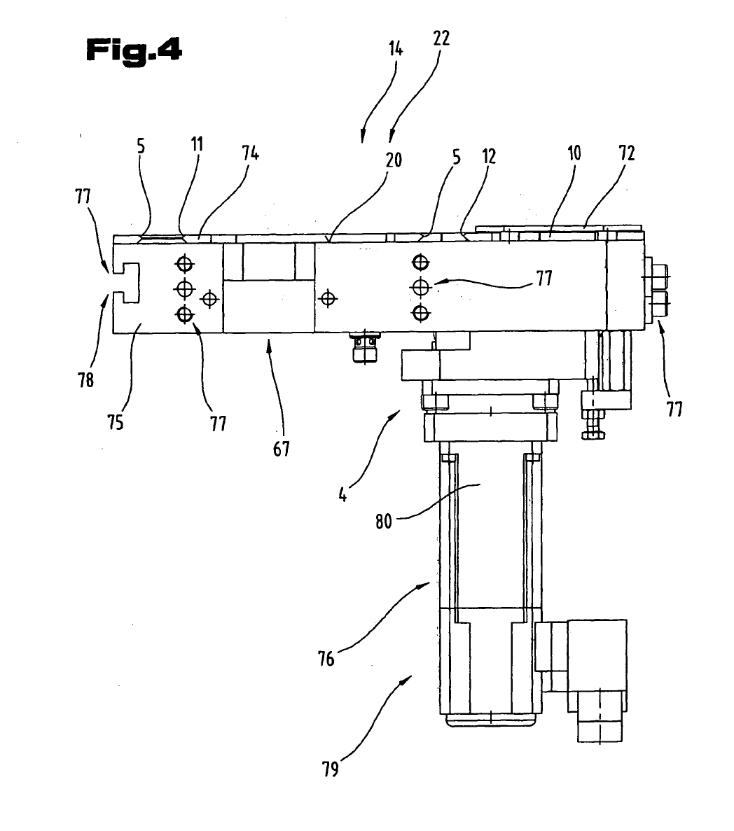

FIG. 4 is a side view of a transfer apparatus;

FIG. 5a is a schematic diagram of a transfer apparatus with two turntables for delivering a parts carrier;

FIG. 5b is a schematic diagram of a transfer apparatus with two turntables for diverting a parts carrier;

FIG. 5c is a schematic diagram of a transfer apparatus with two turntables for diverting a parts carrier;

FIG. 5d is a schematic diagram of a transfer apparatus with two turntables for diverting a parts carrier;

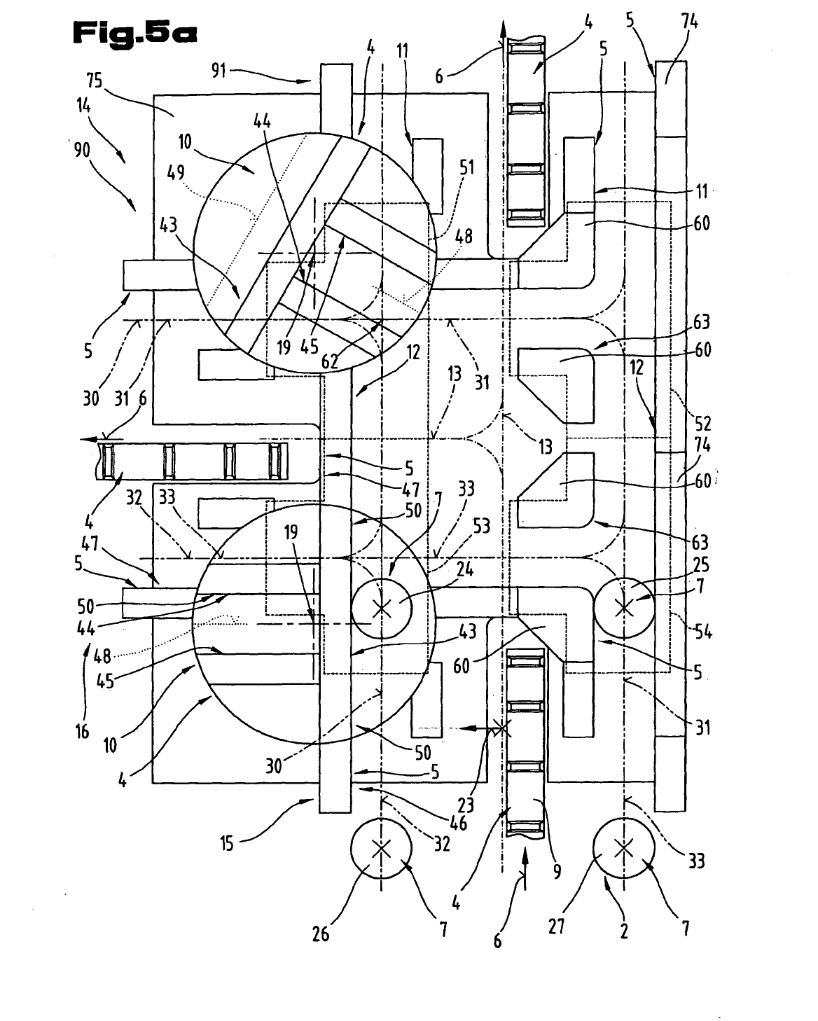

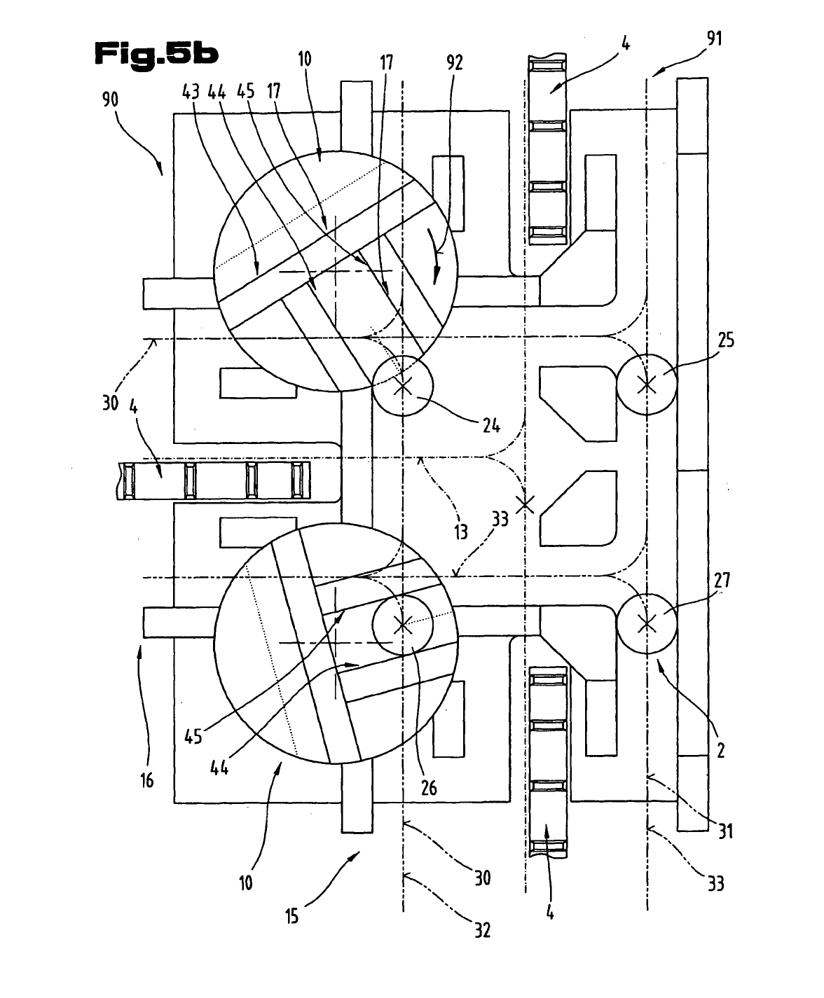

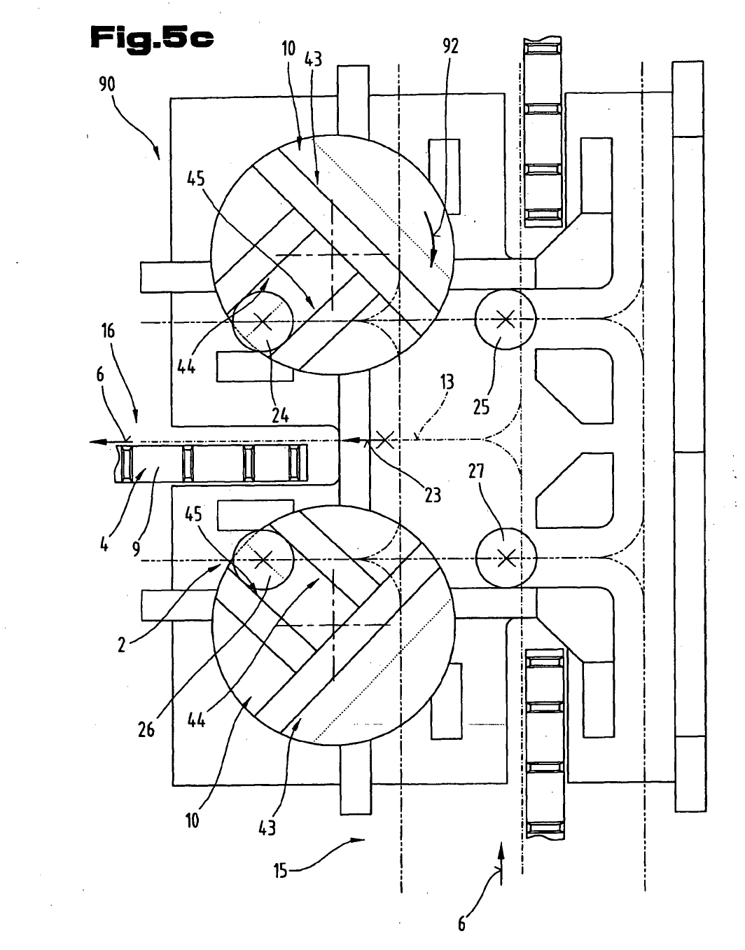

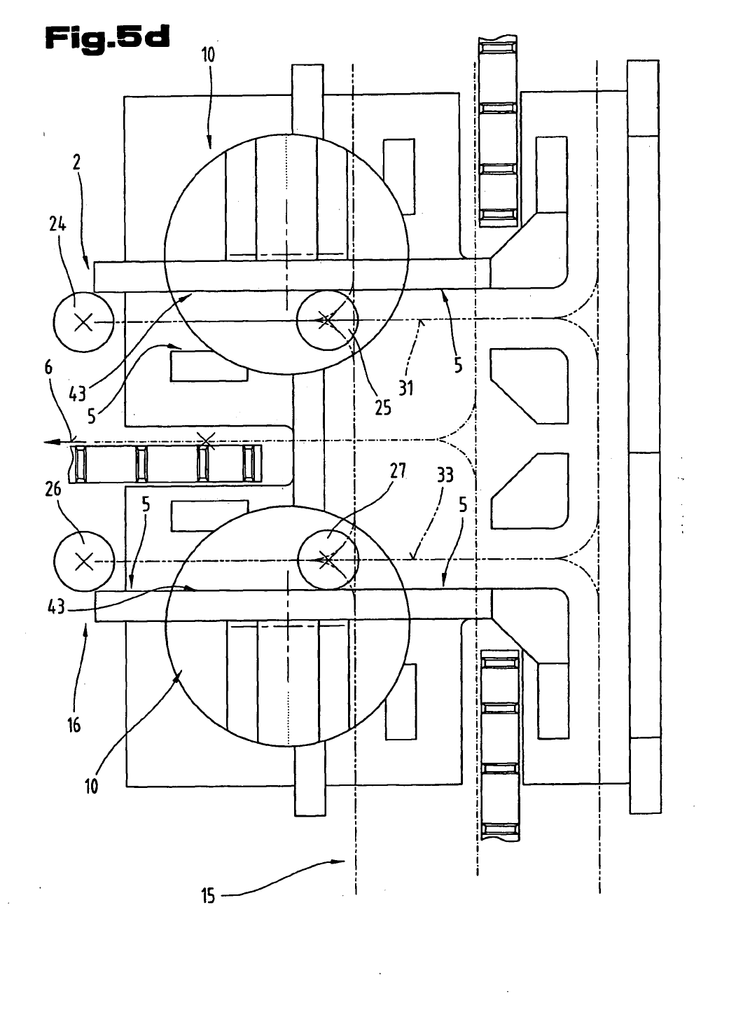

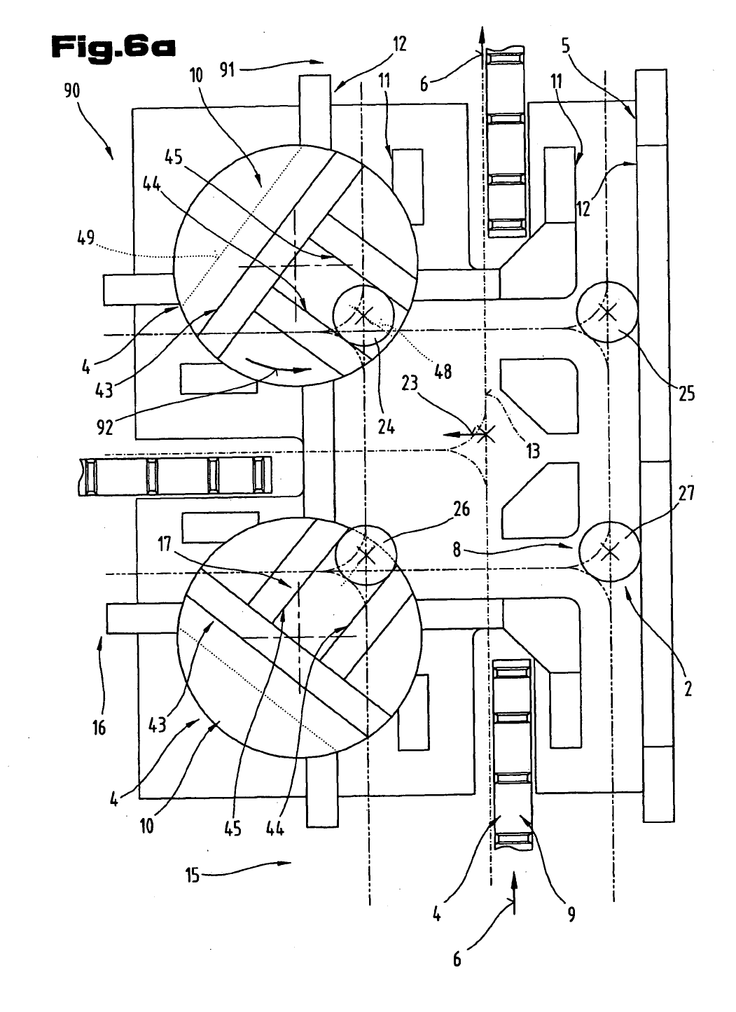

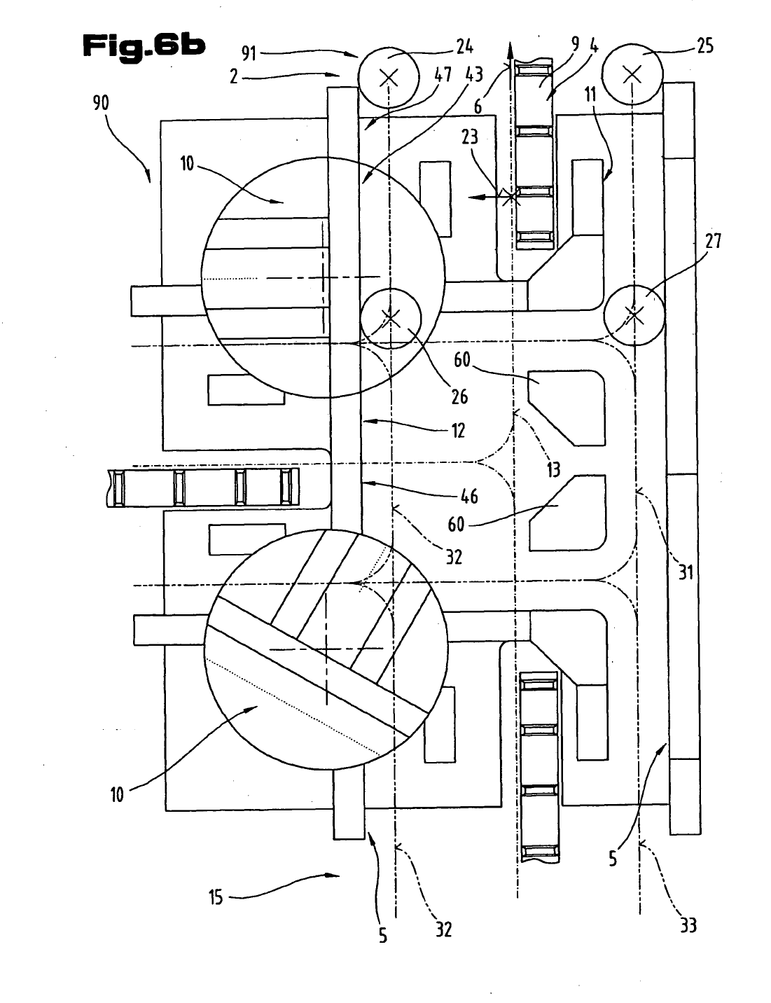

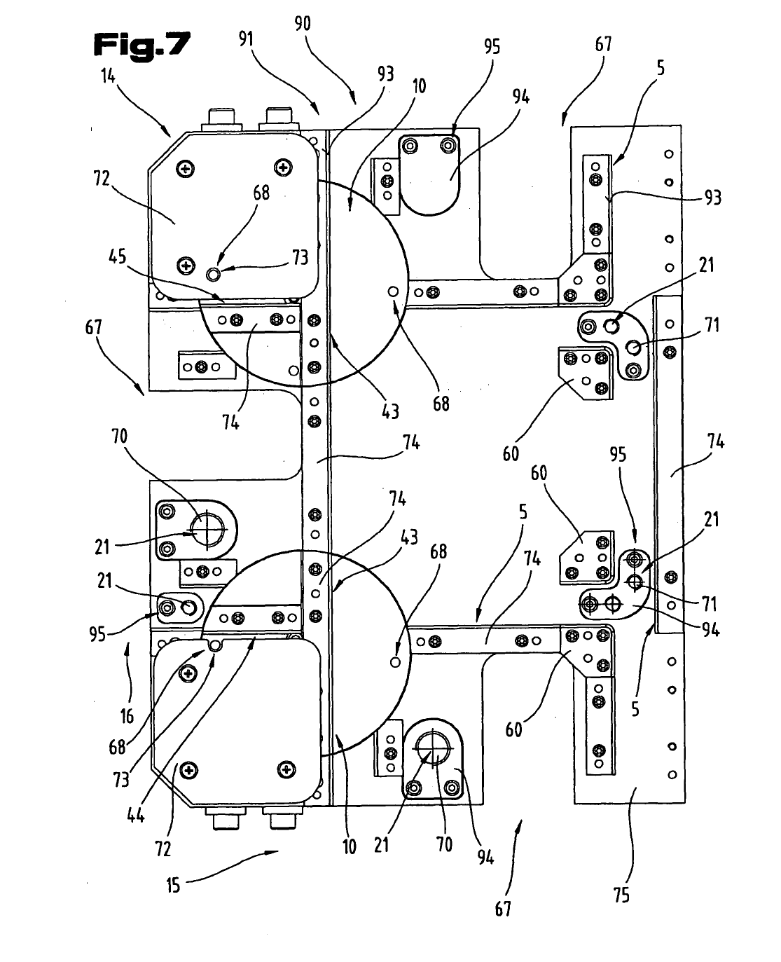

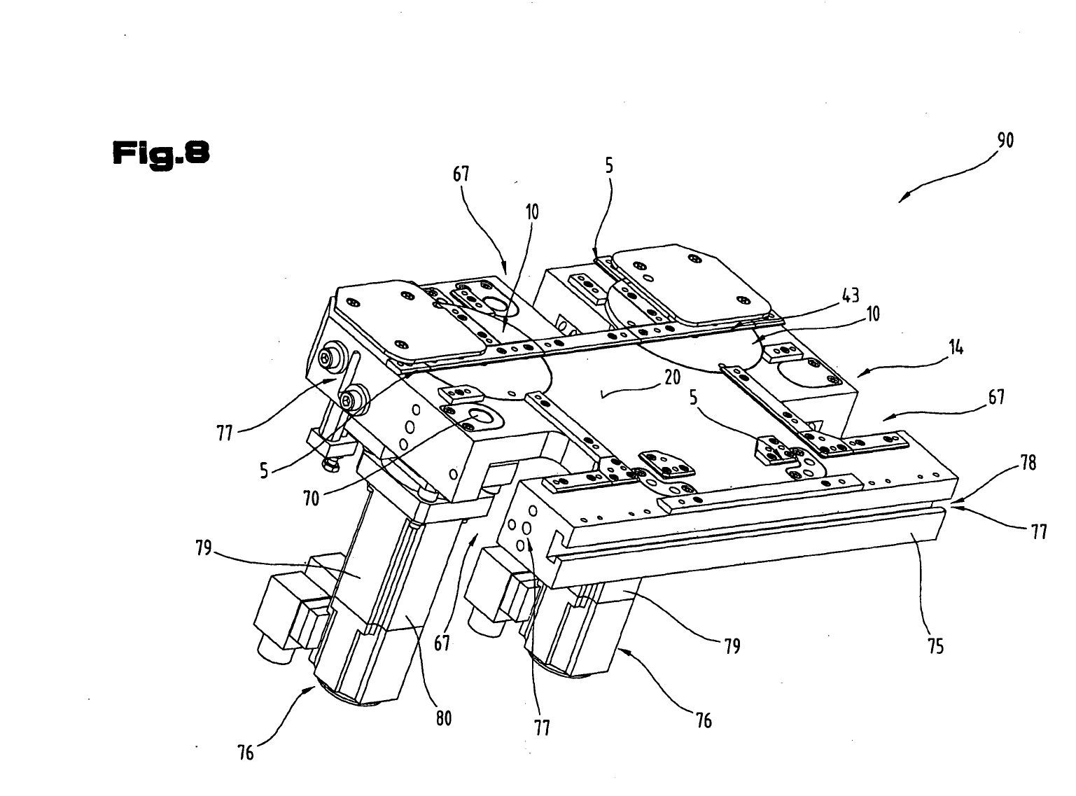

FIG. 6a is a schematic diagram of a transfer apparatus with two turntables for conveying a parts carrier;

FIG. 6b is a schematic diagram of a transfer apparatus with two turntables for conveying a parts carrier;

FIG. 7 is a plan view of a transfer apparatus for diverting or conveying a parts carrier;

FIG. 8 is a perspective view of a transfer apparatus for diverting or conveying a parts carrier;

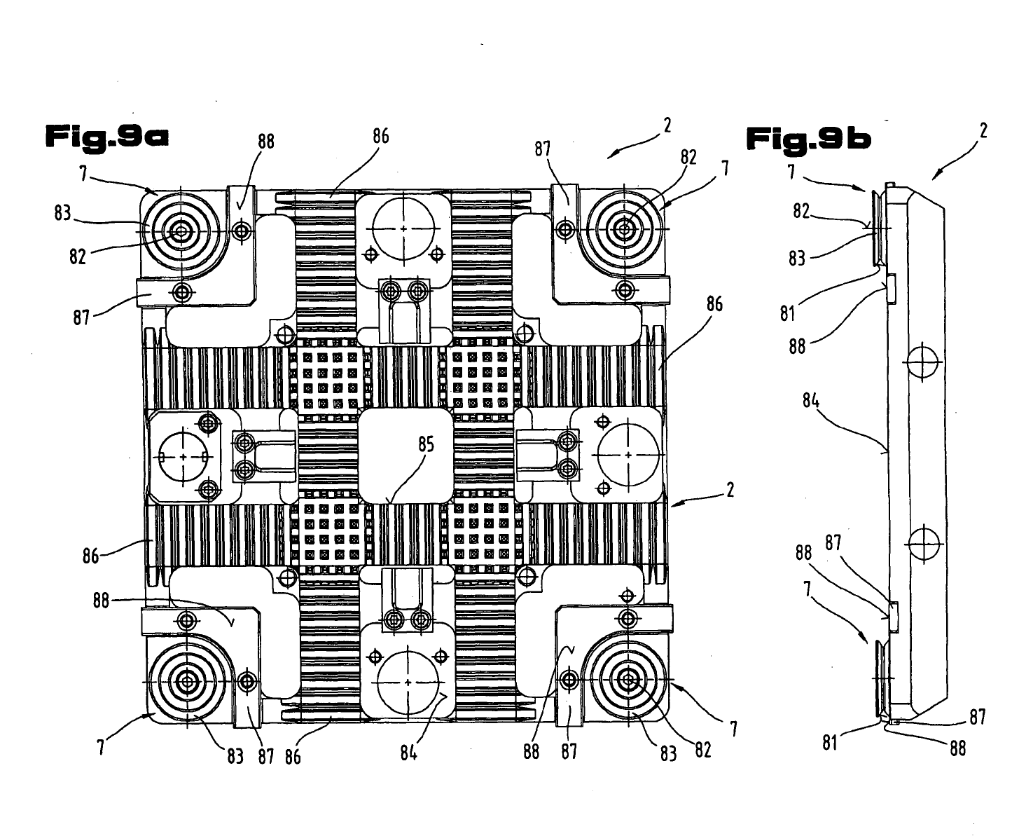

FIG. 9a is a view of a parts carrier from underneath;

FIG. 9b is a side view of a parts carrier;

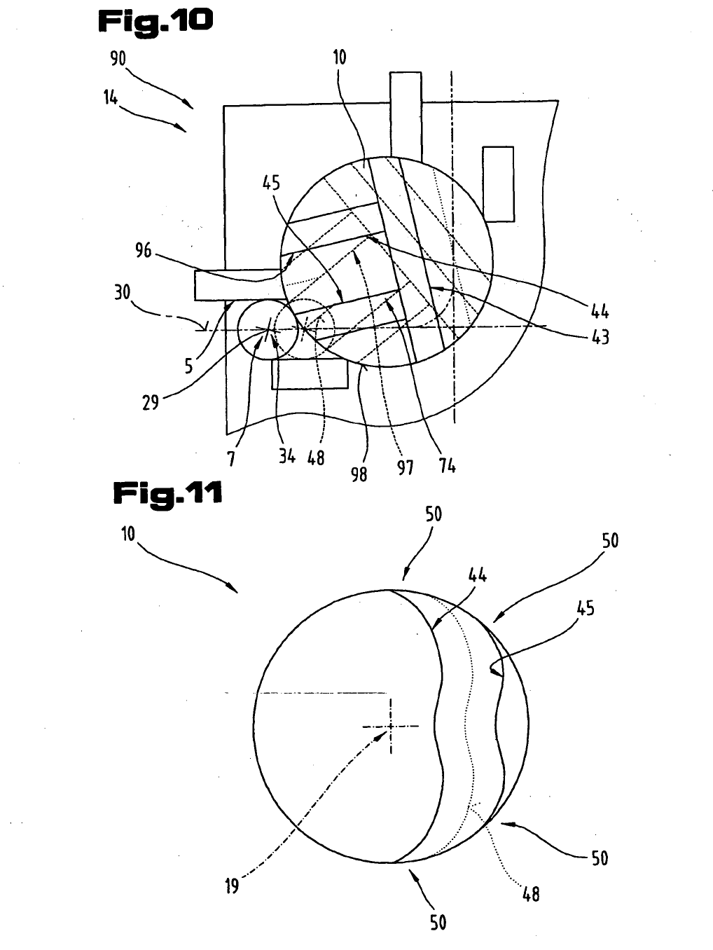

FIG. 10 is a detailed view of a turntable on a transfer apparatus;

FIG. 11 shows a turntable with a guide track extending in a curve;

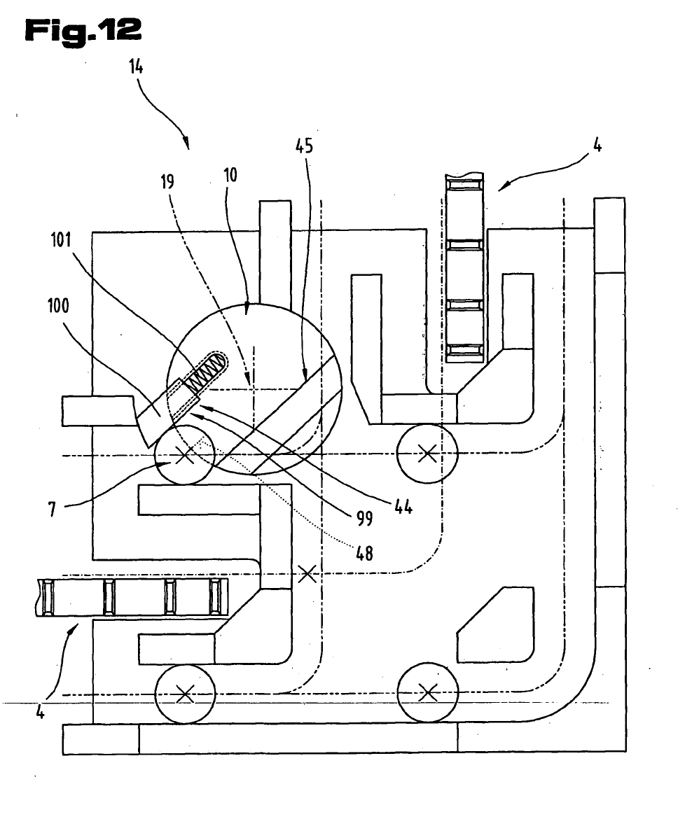

FIG. 12 shows a transfer apparatus with a turntable with a guide track which is able to move relative to the turntable;

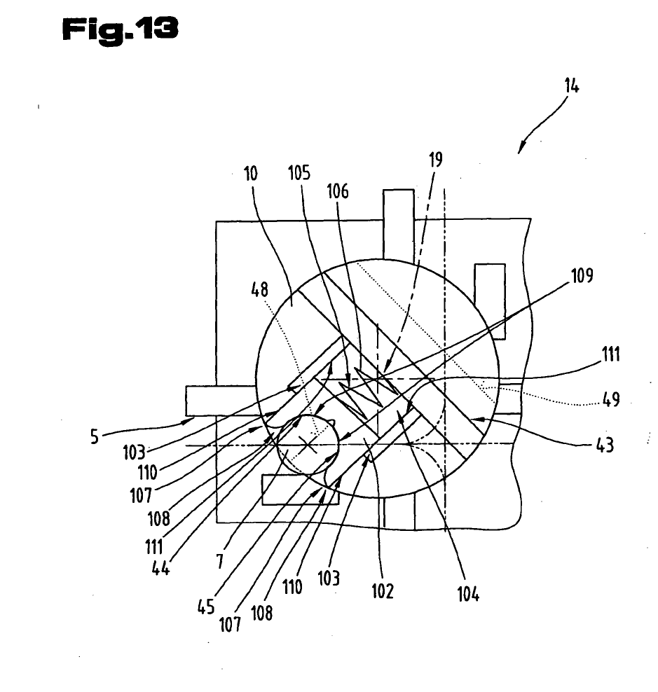

FIG. 13 is a schematic diagram showing a plan view of another embodiment of a turntable;

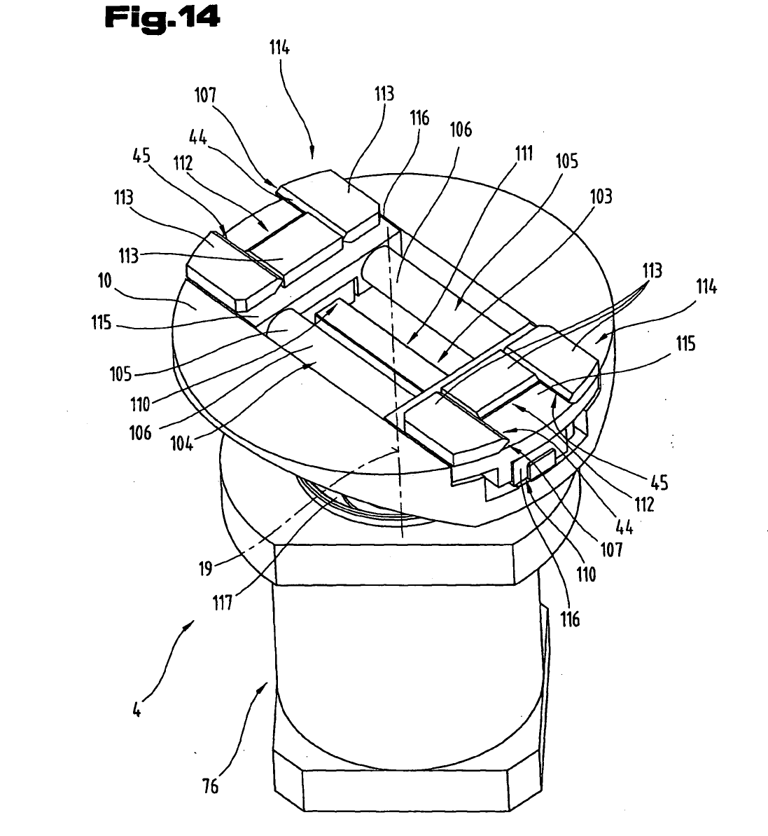

FIG. 14 shows a turntable based on another embodiment.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

For details of how the transport system is secured, reference may be made to the more detailed disclosures of AT 1025/2006 which are included in this subject matter by reference.

FIG. 1a illustrates a section of a transport system 1 for conveying parts carriers 2. To enable the transport system 1 to be set up on the basis a simple and flexible design, the transport system 1 is preferably made up of several transport modules 3. The transport system 1 or transport modules 3 are optionally provided with feeding devices 4, by means of which the parts carrier 2 can be moved or displaced. The transport system 1 also has guide means or guide tracks in at least certain sections, by means of which the parts carrier 2 is guided in the direction of movement 6.

The parts carrier 2 is used to transport and optionally retain an object or a product or several objects or products. The essential thing is that the workpiece carrier assumes an exactly defined position at any one time and is forcibly guided, in particular by guide elements 7 locating in the guide tracks 5.

In order to guide the parts carrier 2 along the guide tracks, it has guide elements 7 which can be moved into engagement with the guide tracks 5. The parts carrier 2 has four guide elements 7 in particular. The guide elements 7 are preferably cylindrical and are provided in particular in the form of rotatable guide rollers 8, 83—FIG. 9a, 9b. It is also possible for the parts carrier 2 to be designed as transport packaging. A detailed description of an embodiment of the parts carrier 2 is given below in connection with the description of the drawings relating to FIGS. 9a and FIG. 9b.

A transport module 3 for the parts carrier 2 comprises a guide means and preferably at least two parallel guide tracks 5 and optionally the feeding device 4, which is designed to move and position the parts carrier 2. The individual transport modules 3 are designed to convey the parts carrier 2 in a line, divert the parts carrier 2 without changing the orientation of the parts carrier 2, referred to below as a transfer operation, and rotate the parts carrier, i.e. in order to change the orientation of the parts carrier 2 and/or for distributing or branching off parts carriers 2 to one of several possible downstream transport modules 3. The transport module 3 is specifically designed to position and/or hold the parts carrier 2.

The feeding device 4 of the transport module 3 is used to convey the parts carrier 2 on the transport module 3. The feeding device 4 can therefore be moved so that it can engage by a positive connection or frictional connection and/or be coupled with the parts carrier 2 at least in certain parts or sections so as to move in unison with it. The feeding device 4 is provided in the form of a traction drive 9 and/or a turntable 10.

The guide tracks 5 of the transport system 1 or transport modules 3 for guiding the parts carrier 2 are disposed transversely opposite one another in the direction of movement 6 of the parts carrier 2. The guide tracks 5 may be provided in the form of inwardly lying guide tracks 11 or—by reference to the parts carrier 2—outwardly lying guide tracks 12. Inwardly lying guide tracks 11 and outwardly lying guide tracks 12 are disposed in certain sections along a displacement path 13.

At least one transport module 3 of the transport system 1 is provided in the form of a transfer apparatus 14, which is design to transfer or pass the parts carrier 2 from a first conveying section 15 to at least a second conveying section 16. The feeding device 4 of the transfer apparatus 14 is provided in the form of at least one turntable 10.

The turntable 10 has a transfer means 17 by means of which a movement of the turntable 10 can be transmitted to the parts carrier 2. The transfer means 17 is preferably provided in the form of at least one guide track 18 which can be moved relative to the guide tracks 5, 11, 12 of a first conveying section 15 or a second conveying section 16. The fact of providing the moving guide track 18 on the turntable 10 means that it moves or can be moved about the pivot axis 19 of the turntable 10.

The pivot axis 19 of the turntable 10 is preferably disposed so that it sits perpendicular to or normally with respect to a transport plane 20 spanned by the guide tracks 5 and which is disposed parallel with the direction of movement of the parts carrier 2 and parallel with the displacement path 13 of the parts carrier 2.

In order to regulate or locate the parts carrier 2 and its movement, the transport modules 3, in particular the transfer apparatus 14, are provided with sensors 21. These sensors 21 are preferably inductive sensors and/or optical sensors, in particular light barriers.

FIG. 1b illustrates a transport system 1 for conveying and optionally processing parts carriers 2 and objects, workpieces or other items disposed on the parts carriers 2. Such objects might be machine elements and/or units of machine elements, for example assembly components for the automotive industry, or other gaseous, liquid, solid objects or objects in a multi-phase state, in particular for medicinal purposes or tests, for example blood samples, medicaments or the materials from which they are manufactured or similar.

Disposed along the transport system 1 are work stations, which process the conveyed object directly on the parts carrier 2 and/or which remove the object from the parts carrier 2, clamp and/or position and fix them on the parts carrier 2 for processing, The work stations may be provided in the form of manual work stations, processing devices, filling and/or emptying devices, feeding devices for feeding assembly parts, measuring apparatus and similar. The processing devices might be milling machines, boring devices, bending machines, welding devices, assembly devices, varnishing and coating devices, shaking and stirring devices, etc.

The transport system 1 preferably has an annular or circular contour so that parts carriers 2 are disposed in a circulation system. The transport system 1, which is preferably made up of several transport modules 3, may also incorporate branches and intersections at which the parts carriers 2 can be branched off, held and/or oriented. The branches and intersections are preferably formed by transfer apparatuses 14.

To enable the parts carrier 2 to be moved in a controlled manner through the transport system 1 or transfer apparatuses 14, drive devices and sensors of the transport system 1 or transfer apparatuses 14 are connected to a control unit. The control unit comprises at least one data carrier, on which a programme for running a method of handling one or several parts carriers 2 and/or a programme for controlling a transfer apparatus 14 is stored. The programmes or programme parts stored on the data carrier are used to control and regulate the orientation and/or position of a parts carrier 2 by means of feeding devices 4 and turntables 10. The position of the parts carrier 2 is clearly defined by the position or status of the feeding devices 4, in particular the turntables 10.

Programmes for running the production sequence, tables, in particular tables for synchronising feeding devices 4, data relating to the status of the objects transported on the parts carrier 2 and data relating to the processing stations may also be stored on the data carrier of the control unit. The data carrier is preferably integrated in a computer unit, in particular in a PC, or control unit, for example in the form of a hard disc, floppy disc, CD and/or as a RAM or ROM module. The computer unit or control unit containing the data carrier is connected to a network for example, to which the computer units and/or control units for other transport systems 1 or other feeding devices 4 are connected. The computer unit or control unit is provided in the form of an industrial PC and/or a memory-programmable controller, for example.

FIGS. 2a to 2e illustrate another embodiment of the transfer apparatus 14 which may be construed as an independent embodiment in its own right, the same reference numbers and component names being used for parts that are the same as those described in connection with FIG. 1 above. To avoid unnecessary repetition, reference may be made to the detailed description given in connection with FIG. 1 above.

The process of transferring, in other words diverting, the parts carrier 2—FIG. 1—without the transfer apparatus 14 changing the orientation 23 of the parts carrier will be described in connection with FIG. 2a to FIG. 2e. The transfer apparatus 14 is therefore a transfer apparatus 22 which diverts the parts carrier 2 about 90° whilst keeping the orientation 23 of the parts carrier constant.

The parts carrier 2 illustrated has four guide elements 7, in particular a first guide element 24, a second guide element 25, a third guide element 26 and a fourth guide element 27, and a central point 28 of the parts carrier 2.

By central point 28 of the parts carrier is meant a point lying at the centre of the guide elements 24, 25, 26, 27 or the centre of gravity of the parts carrier, irrespective of whether it is loaded or not. The central point 28 of the parts carrier 2 is moved in the direction of movement 6 along the displacement path 13.

The mid-points 29 of the guide tracks 24, 25, 26, 27 move on a first guide line 30, a second guide line 31, a third guide line 32 and a fourth guide line 33. The mid-point 29 of the guide elements 24, 25, 26, 27 may also be regarded as a point at which a pivot axis 34 of the guide elements 24, 25, 26, 27 intersects the transport plane 20—FIG. 1. The first guide element 24 moves on the first guide line 30, the second guide element 25 moves along the second guide line 31, the third guide element 26 moves along the third guide line 32 and the fourth guide element 27 moves along the fourth guide line 34.

The feeding device 4 used by the transfer apparatus 22 is the turntable 10, which is preferably disposed along an angle of symmetry 35 of two straight sections 36, 37 of the guide lines 30, 31, 32, 33. The pivot axis 19 of the turntable 10 lies on the angle of symmetry 35 and is approximately perpendicular to it. In the embodiment illustrated in FIG. 2a to FIG. 2e, the pivot axis 34 of the turntable 10 is disposed in a region which does not lie between two guide lines 30, 31, 32, 33. The pivot axis 19 also preferably does not lie on a guide line 30, 31, 32, 33. The pivot axis 19 of the turntable 10 is preferably disposed at a distance 38 from at least one of the guide lines 30, 31, 32, 33 which is in the order of a diameter 39 of a guide element 24, 25, 26, 27.

A diameter 40 of the turntable 10 and the distance 38 between the pivot axis 19 of the turntable 10 and one or more of the guide lines 30, 31, 32, 33 is selected so that the turntable 10 is able to move, in particular can be rotated, when the parts carrier 2 is in a position in which the turntable 10 is disposed in a gap 41 between two guide elements 24, 25, 26, 27, in particular between the first guide element 24 and the third guide element 26. For example, the diameter 40 and pivot axis 19 of the turntable 10 are selected so that a distance between two intersection points of a circle lies with its mid-point on the pivot axis 19 of the turntable 10 and has a diameter which is bigger than the diameter 40 of the turntable 10 by the diameter 39 of a guide element 24, 26, and one of the guide lines 30, 32 is shorter than a distance 42 between two guide elements 24, 26.

In order to guide, deflect and/or drive forward the parts carrier 2, the turntable 10 of the transfer apparatus 22 has a first guide track 43, a second guide track 44 and a third guide track 45. At least one of the guide tracks 43, 44, 45, preferably the first guide track 43, is disposed on the turntable 10 in such a way that when the turntable 10 is stationary, it connects a first guide track portion 46 to a second guide track portion 47 and guides a guide element 24 along a straight section 37 of a guide line 30.

The second guide track 44 of the turntable 10 and the third guide track 45 of the turntable 10 are provided as a means of transmitting driving force to the parts carrier 2, in particular via one of the guide elements 24, 25, 26, 27. When the transfer apparatus 22 is at 90°, the driving force is transmitted to the parts carrier 2 by means of the second guide track 44 and third guide track 45, preferably via the third guide element 26 of the parts carrier 2.

Extending along the guide tracks 43, 44, 45 of the turntable 10 is a first guide line 48 which rotates in unison with the turntable and a second guide line 49 which rotates in unison with the turntable. The first and second guide lines 48, 49 rotating in unison with the turntable are provided in the form of position-related points of the mid-points 29 of the guide elements 24, 25, 26, 27, in particular the first guide element 24 and third guide element 26, connected to the turntable 10 in a stationary arrangement.

The guide tracks 43, 44, 45 disposed on the turntable 10 are arranged on the turntable 10 so that ends 50 of the guide tracks 43, 44, 45 of the turntable 10 can be moved by rotating the turntable 10 into a position in which the ends 50 of the guide tracks 43, 44, 45 of the turntable 10 can be placed on guide tracks 5 fixedly connected to the transfer apparatus 14, 22, in particular on one of the inwardly lying guide tracks 11 and/or on one of the outwardly lying guide tracks 12. Such positions are illustrated in FIG. 2a and FIG. 2e for example, where the ends 50 of the first guide track 43 of the turntable 10 are placed on the outwardly lying guide tracks 12. Such positions are also illustrated in FIGS. 2b and 2d where the ends 50 of the third guide track 45 and second guide track 44 of the turntable 10 are placed on outwardly lying guide tracks 12 and can therefore pick up a guide element 7, 26 from the stationary guide tracks 5.

In the regions 51, 52, 53, 54 of a guide line curve 55, 56, 57, 58, the guide lines 30, 31, 32, 33 have a radius 59 which is bigger than half the diameter 39 of a guide element 24, 25, 26, 27. The radius 59 of the guide lines 31, 32, 33 or guide line curves 55, 56, 57, 58 preferably has a value corresponding to between 1.1 times to 2 times half the diameter 39 of one of the guide elements 24, 25, 26, 27. In particular, the radius 59 of the guide lines 30, 31, 32, 33 or guide line curves 55, 56, 57, 58 is approximately 1.5 times bigger than half the diameter 39 of one of the guide elements 24, 25, 26, 27.

In the regions 51, 52, 54 of the guide line curves 55, 56, 58 in which the turntable 10 is not disposed, not even partially, an inner guide track element 60 and optionally an outer guide track element 61 is preferably provided on the transfer apparatus 14, 22.

Inwardly lying guide tracks 11 and outwardly lying guide tracks 12 are disposed in at least certain sections of the transfer apparatus 14, 22, for example in the area lying at a distance of up to 25% to 200% of a distance 37 between two guide elements 24, 25, 26, 27, in one or more of the regions 51, 52, 53, 54 of a guide line curve 55, 56, 57, 58 and/or in a region shortly before or shortly after a guide line 30, 32, 33 extending across the turntable 10 by reference to the direction of movement 6 of the parts carrier 2.

An intersection 62 of two guide lines 30, 33 and/or optionally at least one guide line curve 57 lies in the region of the turntable 10, and in particular these lie above the turntable 10.

The sequence involved in sliding the parts carrier 2 across by means of the transfer apparatus 22 will be described below with reference to FIG. 2a to FIG. 2e.

At the start, the parts carrier 2 is fed in the direction of movement 6 to the transfer apparatus 14, 22 along inwardly lying guide tracks 11 and/or outwardly lying guide tracks 12 along a first conveying section 15 by means of the feeding device 4, in particular the traction drive 9. During the feeding operation, the position of the rotatable turntable 10 about the pivot axis 19 may still be undefined.

The position of the parts carrier 2 can be defined by sensors 21—FIG. 1. Once the parts carrier 2 arrives in the vicinity of the transfer apparatus 14, 22 or turntable 10, the turntable 10 is preferably rotated into a transfer position, as illustrated in FIG. 2a. In the transfer position, the second guide track 44 of the turntable 10 preferably establishes a connection between the first guide track portion 46 and the second guide track portion 47 so that the first guide element 24 of the parts carrier 2 moves past the turntable 10 without turning the turntable 10. Until just before reaching the des third guide element 26 of the parts carrier 2 of the turntable 10, the parts carrier 2 is driven or conveyed by the feeding device 4 of a projecting transport module 3—FIG. 1—for example by a traction drive 9.

Once the first guide element 24 of the parts carrier 2 has moved past the turntable 10, the turntable 10 and second guide track 44 and if necessary also the third guide track 45 of the turntable 10 is rotated into a handover position or transfer position—illustrated in FIG. 2b—for the third guide element 26. The pick-up position or handover position may be reached when the second guide track 44 of the turntable 10 and/or the third guide track 45 of the turntable 10 or respectively an end 50 of these guide tracks 44, 45 lies against the inwardly lying guide track 11 and/or outwardly lying guide track 12 leading to a third guide element 26 and/or alongside the third guide element 26 itself. In particular, the turntable 10 is moved so that the guide line 48 which rotates in unison with the turntable always lies in the direction towards the mid-point 29 of the third guide element 26. In the pick-up position or handover position, the turntable 10 and at least the second guide track 44 and/or third guide track 45 preferably always move at a defined speed adapted to the guide element 26 or parts carrier 2 and optionally at an adapted acceleration. In this respect, the initial speed or acceleration is selected so that no or only slight sudden forces act on the parts carrier 2 in the pick-up position or handover position and the parts carrier is picked up from the turntable 10 or its guide tracks 43, 44, 45 as far as possible without any jerking movement.

In the pick-up position or handover position, the turntable 10 picks up the third guide element 26, which is conveyed by the feeding device 4 of a transport module 3 disposed upstream—FIG. 1. When the turntable 10 is rotated farther, the parts carrier 2 is driven and positioned by the third guide element 26 and the second guide track 44 and/or third guide track 45.

Due to the guide track 5 fixedly disposed on the transfer apparatus 14, 22, the parts carrier 2 or a central point 28 of the parts carrier 2 is fed along the displacement path 13 in the direction of movement 6 with the orientation 23 remaining constant.

Once the third guide element 26 has been picked up by the turntable 10 and the second guide track 44 and/or third guide track 45, the turntable 10 is rotated, thereby causing the parts carrier 2 to be conveyed onwards. The parts carrier 2 is moved in a straight line in the first conveying section 15 until the guide elements 24, 25, 26, 27 arrive at the guide line curves 55, 56, 57, 58. The guide elements 24, 25, 26, 27 are deflected by inwardly lying guide track curves 63 and/or outwardly lying guide track curves 64 so that the direction of movement 6 changes. As the parts carrier 2 slides across, its direction of movement 6 changes but the orientation 23 remains the same. A radius 65 of an inner guide track curve 63 corresponds to the radius that is reduced by the half diameter 39 of a guide element 24, 25, 26, 27. A radius 66 of an outer guide track curve 64 is bigger than the radius 65 of an inwardly lying guide track curve 63 by approximately the diameter 39 of a guide element 24, 25, 26, 27. An inwardly lying guide track curve 63 is preferably provided on an inner curved element 60. An outer guide track curve 64 is preferably provided on an outer curved element 61.

The parts carrier 2 is deflected by the inner guide track curve 63 and/or the outer guide track curve 64 and by the curved elements 60, 61, as illustrated in FIG. 2c. To bring about the deflection, the first guide element 24 and the fourth guide element 27 engage with the guide track curve 63, 64 disposed in the respective regions 51, 54, in particular an inner guide track curve 63. The second guide element 25 engages with an inner guide track curve 63 and/or outer guide track curve 64 disposed in the region 52 where the second guide line 31 of the second guide element 25 is disposed around the guide line curve 56 and is deflected by it. In region 52, the second guide element 25 and fourth guide element 27 are preferably deflected by only the outer guide track curve 64, in which case a curved element 60 with an inner guide track curve 63 can be dispensed with.

The feeding movement for the parts carrier 2 is transmitted by means of the third guide element 26 engaging with the turntable 10 and the guide tracks 43, 44, 45 disposed on it. Due to the rotation of the turntable 10, the parts carrier 2 is moved as far as a transfer position or handover position as illustrated in FIG. 2 d, where the third guide element is handed over by the turntable 10 and second guide track 44 and/or third guide track 45 to guide tracks 5, in particular the inwardly lying guide track 11 and/or outwardly lying guide track 12 for onward transportation. From the transfer position or handover position of the turntable 10 in which the third guide element 26 leaves the turntable 10, the parts carrier 2 is conveyed onwards and positioned by the feeding device 4 of a subsequent transport module 3, in particular the traction drive 9.

The transfer position or handover position is determined by the angular position of the turntable 10 in which the end 50 or an end point of the second guide track 44 of the turntable 10 and/or the end 50 or an end point of the third guide track 45 of the turntable 10 lies alongside the subsequent inwardly lying guide track 11 and/or outwardly lying guide track 12 of a subsequent second conveying section 16. The transfer position may also be the position of the turntable 10 in which the end 50 of the second guide track 44 of the turntable 10 or the end 50 of the third guide track 45 of the turntable 10 is disposed on a shortest connecting line between the mid-point 29 of the third guide element 26 and the pivot axis 19 of the turntable 10. By preference, the turntable 10 does not stop in the transfer position abruptly but is again moved at a rotation speed or rotational acceleration adapted to the parts carrier 2.

Even before the fourth guide element 27 reaches the turntable 10, the turntable 10 is moved into a position in which the fourth guide element 27 of the parts carrier 2 is able to move past the turntable with or without a rotating movement of the turntable 10 and in which the fourth guide element 27 engages with and is guided by a guide track 43, 44, 45, in particular the first guide track 43. This transfer position of the turntable 10 as the fourth guide element 27 moves past the turntable 10 is illustrated in FIG. 2e.

In the transfer position, the parts carrier 2 and co-operating guide element 7 is secured and retained in a direction lying transversely to the direction of movement 6 by one of the guide tracks 43, 44, 45 of the turntable 10, in particular the first guide track 43 of the turntable 10.

FIG. 3 illustrates another embodiment of the transfer apparatus 22 which may be construed as an independent solution in its own right, the same reference numbers and component names being used for parts that are the same as those used in connection with FIG. 1 to FIG. 2e above. To avoid unnecessary repetition, reference may be made to the detailed description given in connection with FIG. 1 to FIG. 2e above.

The transfer apparatus 14, 22 illustrated in FIG. 3 comprises the turntable 10, guide tracks 5, sensors 21 and optionally recesses 67 for accommodating conveyor devices or feeding devices 4—FIG. 1—of preceding and subsequent transport modules 3—FIG. 1—in particular the traction drive 9—FIG. 1.

The turntable 10 preferably has at least one means 68 for determining a reference position of the turntable 10. The means 68 is provided in the form of one or more bores 69 which can be located by a sensor, in particular a light barrier sensor and/or an inductive sensor. For example, a light barrier sensor which is stationary relative to the transfer apparatus 22 is provided and the distance of the light beam from the pivot axis 19 of the turntable 10 corresponds more or less to the distance of the means 68 or bore 69 from the pivot axis 19 of the turntable 10. By rotating the turntable 10 in a controlled manner, it is possible to ascertain from what position the light beam of the light barrier sensor is obstructed or is no longer obstructed. This enables a conclusion to be drawn about the position of the turntable 10.

In order to determine the position of the parts carrier 2—FIG. 1—or guide elements 24, 25, 26, 27—FIG. 2a—of the parts carrier 2—FIG. 1—the sensors 21 are disposed on the transfer apparatus 14, 22 in a region along the guide tracks 5, for example between inwardly lying guide tracks 11 and outwardly lying guide tracks 12, and in a first conveying section 15 and/or in a second conveying section 16. In order to ascertain when the parts carrier 2—FIG. 1—has arrived at or moved away from the transfer apparatus 14, 22, sensors 70 are provided in a region bounded by other transport modules 3. The sensors 70 are designed to detect the position and presence of the parts carrier 2—FIG. 1—and preferably have a measurement range extending as far as a distance approximately corresponding to the distance 37 between two guide elements 24, 25, 26—FIG. 2a. These sensors 70 indicate to a control system, in particular a process management system, when a transfer operation should be started or initiated. Sensors 71 designed to detect the guide elements 24, 25, 26, 27—FIG. 2a—are also disposed along the guide tracks 5, in particular in regions 51, 52, 54—FIG. 2a—of guide line curves 55, 56, 58, —FIG. 2a. The sensors for detecting the guide elements 24, 25, 26, 27 are designed to detect the position of the guide elements and are used to control the transfer operation, in particular during a change in the direction of movement 6—FIG. 2a. In particular, these sensors 71 for detecting the guide elements 7 are used to ascertain and/or automatically control a speed of the parts carrier 2—FIG. 1.

Also disposed above the turntable 10 is a bridging element 72. The bridging element 72 increases the safety of the transfer apparatus 22 for example, because it makes it more difficult for a user to inadvertently move in this area. Another variant is possible whereby guide tracks 5 are provided on at least certain portions of the bridging element 72, the purpose of which is to guide one or more guide elements 24, 25, 26, 27, in particular to guide the first guide element 24, third guide element 26 and fourth guide element 27. The bridging element 72 preferably also has a recess 73 for the means 68 used fix secure the position of the turntable 10.

FIG. 4 shows a side view of the transfer apparatus 22 illustrated in FIG. 3, the same reference numbers and component names again being used to denote parts that are the same as those described in connection with the drawings above. To avoid unnecessary repetition, reference may be made to the detailed description of FIG. 1 to FIG. 3 above.

The guide tracks 5, in particular the inwardly lying guide tracks 11 and outwardly lying guide tracks 12, are preferably disposed on guide track elements 74 and curved elements 60, 61—FIG. 3—which are mounted on a mounting element 75. The turntable 10, optionally the bridging element 72 and a drive device 76 for the feeding device 4 are also disposed on the mounting element 75. The mounting element 75 is made by an aluminium casting process, for example, in order to obtain better vibration properties and save on weight. The mounting element 75 is preferably more or less plate-shaped. The mounting element 75 also has connecting mechanisms 77 which are used to connect the transfer apparatus 22 to other transport modules 3 and/or a support frame or support units (not illustrated) on which different trans-port modules 3 and/or devices for handling the objects or products transported on the parts carrier 2 may be disposed.

The connecting mechanism 77 of the mounting element 75 is provided in the form of a groove 78, for example, which is T-shaped in particular. The groove 78 preferably extends to the side of the transfer module 22, in particular on a side extending at a right angle to the transport plane—FIG. 1. The contour of the groove 78 is parallel with the transport plane 20—FIG. 1. It is also possible for the groove 78 to extend perpendicular to the transport plane 20—FIG. 1. The connecting mechanism 77 and the specifically T-shaped groove 78 are designed so that the transfer module 22 can be mounted so that it can be varied, in particular adjusted in terms of height and/or lateral position. The connecting mechanism 77 may also be provided in the form of screw connections and/or push-fit connections. Accordingly, centring pins and/or bores may be provided on the mounting element 75 to permit an exact fit of the transport module 3, in particular the guide tracks 5.

The drive device 76 is provided in the form of an electric motor 79, for example, in particular a servo-motor 80. The drive device 76, in particular the servo-motor 80, is connected to the turntable 10 via a gear, either directly or indirectly. The drive device 76 is designed to move the turntable 10 and the guide tracks 5 disposed on it, in particular the first, second and/or third guide track 43, 44, 45, of the turntable 10, in particular in a rotating motion.

FIGS. 5a to 5d respectively FIGS. 6a and 6b illustrate another embodiment of the transfer apparatus 14 which may also be construed as an independent solution in its own right, the same reference numbers and component names being used to describe parts that are the same as those described in connection with FIGS. 1 to 4 above. To avoid unnecessary repetition, reference may be made to the detailed description of FIGS. 1 to 4 above.

The transfer apparatus 14 illustrated in FIGS. 5a to 5d respectively 6a and 6b is provided in the form of a transfer apparatus 90 which is able to direct or branch off a parts carrier 2 from a first conveying section 15 to a second conveying section 16 or direct the parts carrier 2 from the first conveying section 15 to a third conveying section 91. The transfer apparatus 90 may therefore be regarded as a switching point for the parts carrier 2. The direction of movement 6 of the parts carrier 2 in the first conveying section 15 is preferably parallel or flush with one possible direction of movement 6 in the third conveying section 91. The possible direction of movement 6 of the parts carrier 2 in the second conveying section 16 preferably extends at an angle to a direction of movement 6 of the first conveying section 15 and/or third conveying section 91. For example, an angle between the direction of movement 6 of the first conveying section 15 and the direction of movement 6 of the second conveying section 16 is between 30° and 150°, in particular approximately 90°. This results in a Y-shaped or T-shaped intersection.

In order to move the parts carrier 2 along the conveying sections 15, 16, 91, they are preferably each provided with a feeding device 4, in particular a traction drive 9, by means of which the parts carrier is driven in a positive or friction-based arrangement and thus fed to the transfer apparatus 90 or fed away from the transfer apparatus 90. Accordingly, the parts carrier 2 is preferably driven in the same manner as described above.

To enable the parts carrier 2 to be branched off or conveyed onwards by the transfer apparatus 90, the transfer apparatus 90 has at least two turntables 10 designed to guide and transmit a driving force to the parts carrier 2. The turntables 10 may be designed and mounted in the same manner as that described in connection with the drawings above.

In order to guide the parts carrier 2, he transfer apparatus 19 is provided with guide tracks 5 mounted on it so as to be stationary. The guide tracks 5 of the transfer apparatus 90 connect the first, second and third conveying sections 15, 16, 91 directly or indirectly via the turntables 10. A direct connection is obtained by the outwardly lying guide track 12 for example, which links the first conveying section 15 to the third conveying section 91 and is disposed lying opposite the turntables 10. An indirect connection via the turntables 10 is obtained by means of the guide tracks 43, 44, 45 disposed on the turntables 10, by means of which the parts carrier 2 and one or more guide elements 7 are guided in at least certain sections. The guide tracks 5, in particular the inwardly lying guide tracks 11 and/or outwardly lying guide tracks 12, together with the two turntables 10 of the transfer apparatus 19, guide the parts carrier 2 along the guide lines 30, 31, 32, 33. The parts carrier 2 may optionally also be guided by a feeding device 4 of the first, second and/or third guide section 15, 16, 91, in particular the traction drive 9.

In the regions 51, 52, 53, 54 where there is a branch and/or a curve in the guide lines 30, 31, 32, 33, curved elements 60 are preferably provided in order to guide the parts carrier 2 and guide elements 7 of the parts carrier 2 along the guide lines 30, 31, 32, 33 in a curved region. The curved elements 60 preferably have a guide track curve 63 with a radius 65—FIG. 2c—of between 2 mm and 10 mm for example.

In another variant of the curved elements 60, they have a guide track curve 63 which does not have a constant radius 65 and instead, the radius of the guide track curve 63 or curved element 60 changes continuously along the guide track curves 63. At the start, i.e. in a region in which a guide track 5 extending in a straight line merges into the curve, the guide track curve 63 has a slight curvature, in particular a curvature close to zero, which then increases as far as a region towards the end of the guide track curve 63 where it merges back into a straight guide track 5 again, decreases or returns to zero. The respective radius of the guide track curve 63 at any one time conforms to the curvature of the guide track curve 63. Based on this embodiment of the guide track curve 63, the sudden occurrence of a centrifugal force caused by a deflection, which is dependent on the radius of the guide track curve 63, can be prevented. The advantage of a guide track curve 63 based on this design, especially when conveying liquids in an open vessel, for example blood in blood sample test tubes, is that any spillage of the liquid can be prevented.

At this stage, it should be pointed out that the positions of the turntables 10 and their pivot axes 19 and the size and shape of the turntables 10 and guide tracks 43, 44, 45 disposed on the turntable 10 as well as the disposition or position of the guide tracks 43, 44, 45 of the turntable 10 with respect to one another and/or to the stationary guide tracks 5 disposed on the transfer apparatus 14, 22, 90, in particular the inner guide tracks 11 and/or outer guide tracks 12, are selected so that the position or dynamic status of the parts carrier 2 on the transfer apparatus 14, 22, 90 is determined at least along big movement runs due to the position of the turntables 10.

The sequence of the transfer operation with a change of 90° in the direction of movement of the parts carrier 2 by means of the transfer apparatus 91 will be described below with reference to FIG. 5a to FIG. 5d.

During a first step, the parts carrier 2 is moved in the direction of movement 6 along the first conveying section 15 to the transfer apparatus 90 along inwardly lying guide tracks 11 and/or outwardly lying guide tracks 12 by means of the feeding device 4, in particular the traction drive 9. The position of a first turntable 10 lying closer to the first conveying section 15 is disposed in a transfer position in which the first guide element 24 of the parts carrier 2 is fed parallel with the direction of movement 6 of the first conveying section 15 across the turntable 10. To this end, the turntable 10 is provided with the first guide track 43, which connects two stationary guide tracks 5 of the transfer apparatus 90 to one another in a straight line. The first guide track 43 of the turntable 10 together with the guide tracks 5 of the first conveying section 15 form parallel guide tracks lying transversely opposite in the direction of movement 6 of the first conveying section 15, as a result of which the parts carrier 2 is secured to prevent any movements transversely to the direction of movement 6 of the first conveying section 15. The turntable 10 preferably is preferably not rotated in order to pass the first guide element 24 of the parts carrier 2.

In another step, immediately on leaving the first guide element 24 of the parts carrier 2 and before arriving at the third guide element of the parts carrier 2 in the operative region of the first turntable 10, the first turntable 10 is rotated into a pick-up position for the third guide element 26 of the parts carrier 2 by means of the second guide track 44 and optionally the third guide track 45. The pick-up position of the first turntable 10 for the third guide element 26 is thus based on a specific or defined position, a defined speed, a defined acceleration and optionally a pre-defined change of acceleration over time. The position or disposition, speed, acceleration and change in acceleration by reference to the turntable 10 should be understood as meaning angular positions or angular dispositions, angular speed, angular acceleration and the change in angular acceleration.

The position, speed, acceleration and optionally the change in acceleration of the turntable 10 over time in a pick-up position are preferably adapted to the guide element 7 to be picked up so that the transfer can take place without any jerky movements.

Once the third guide element 26 has been picked up by the first turntable 10, the parts carrier 2 is driven along the guide lines 30, 31, 32, 33 and guided by means of the first turntable 10 and third guide element 26. In another step, a second turntable 10 is moved into a state in which the second turntable 10 is such that the first guide element 24 of the parts carrier 2 can be picked up by means of the guide tracks 44, 45 disposed on the turntable and connected to it. Amongst other things, this means that the second turntable 10, even before the first guide element 24 of the second turntable 10 is reached, is set in motion so that the guide tracks 44, 45 of the second turntable 10 are adapted to the position, speed, acceleration and optionally the change over time in acceleration of the first guide element 24 and parts carrier 2 until the second turntable 10 and guide tracks 44, 45 of the second turntable 10 establish an initial contact with the first guide element 24 of the parts carrier 2. This enables the first guide element 24 of the parts carrier 2 to be picked up by the transfer means 17 of the second turntable 10 without any jerking movements or impacts.

In order to co-ordinate the movement of the turntables 10 and optionally to co-ordinate the first turntable 10 and second turntable 10 with the feeding devices 4, in particular the traction drives 9, the conveying sections 15, 16, 91 of other transport modules 3—FIG. 1—adjoining the transfer apparatus 90 are synchronised with them with the aid of a synchronisation table. With a view to evaluating and running the synchronisation table, yet other sensor data may also be used, such as data from sensors on the transfer apparatus 90, sensors on other trans-port modules 3 and/or sensors on the parts carrier 2, for example. With the aid of the synchronisation table, which is preferably stored in a data carrier of a control device for the transport system 1—FIG. 1—the drive devices 74—FIG. 4—are then automatically controlled and activated by the control device.

In order to move the second turntable 10 into a state ready for picking up the first guide element 24 of the parts carrier 2, it is moved in a direction of rotation 92 before reaching the first guide element 24 of the second turntable 10 already.

Once the first guide element 24 has been picked up by the second turntable 10 and guide tracks 44, 45 of the second turntable 10, the latter is rotated farther in the clockwise direction, whilst the first turntable 10 guiding and driving the third guide element 26 by means of the guide tracks 44, 45 of the first turntable 10 is rotated in the anti-clockwise direction. As a result, the direction of movement 6 of the parts carrier 2, starting from the first conveying section 15, is superimposed on a direction of movement 6 of the second conveying section 16 extending at approximately 90° with respect to it. The transfer operation in this instance involves a change in the direction of movement 6 of the parts carrier 2 without changing the orientation 23 of the parts carrier 2. The orientation 23 of the parts carrier 2 in the second conveying section 16 is therefore parallel with the orientation 23 of the parts carrier 2 in the first conveying section 15.

The parts carrier 2 is driven by the first and second turntable 10 until the parts carrier 2 is handed on to a feeding device 4, in particular a traction drive 9, of the transport module 3—FIG. 1—of the second conveying section 16 and can be forwarded onwards. Optionally, before reaching the feeding device 4 of the transport module 3 of the second conveying section 16, the parts carrier 2 can be moved more quickly or more slowly by the turntables 10, and in particular may also be held back by a specific, pre-definable holding time so that the interval between a first parts carrier 2 and a subsequent parts carrier 2 can be adapted to other processing steps, in particular the interval can be made longer or shorter.

As soon as the first guide element 24, second turntable 10 and third guide element 26 have left the first turntable 10 and its respective guide tracks 44, 45 and been fed out of the operating range, the first and second turntables 10 and their first guide tracks 43 are rotated into a transfer position as illustrated in FIG. 5 d. In this transfer position, the second guide element 25 and fourth guide element 27 of the parts carrier 2 are secured to prevent movements transversely to the direction of movement 6 of the second guide section 16 and are guided along the guide lines 31, 33. The first and second turntables 10 of the transfer apparatus 90 are preferably stationary whilst the second guide element 25 and fourth guide element 27 of the parts carrier 2 are being transferred and serve as parallel guides lying transversely opposite in the direction of movement 6 of the second conveying section 16 due to the first guide track 43 together with the guide tracks 5 fixedly disposed on the transfer apparatus 90 respectively.

With reference to FIGS. 6a and 6b, a brief description will be given of method steps whereby the parts carrier 2 is fed in an at least approximately straight line across the transfer apparatus 90. The positions of the turntables when the parts carrier 2 arrives at the transfer apparatus 90 correspond to those of the steps described with reference to FIG. 5a. In other words, the parts carrier 2 is fed to the transfer apparatus 90 by means of the feeding device 4, in particular a traction drive 9, of the preceding transport module 3—FIG. 1. The first turntable 10 is disposed in a transfer position in which the first guide element 24 of the parts carrier 2 is fed by means of the first guide track 43 of the first turntable 10 in a direction parallel with the first and third conveying sections 15, 91. Once the first guide element 24 of the parts carrier 2 has left the operating range of the first turntable 10 and first guide track 43 of the first turntable 10 and before the third guide element 26 has reached the first turntable 10 or operating range of the first turntable 10, the first turntable 10 is moved into a state ready for picking up the third guide element 26. Accordingly, the angular position, rotation speed, rotational acceleration and optionally the change in rotational acceleration of the first turntable 10 are adapted to the position, speed, acceleration und optionally the change in acceleration of the third guide element 26 of the parts carrier 2, to enable the third guide element 26 to be picked up by the second guide track 44 and optionally the third guide track 45 of the first turntable 10 without jerking movements.

Before the first guide element 24 of the parts carrier 2 arrives at the second turntable 10 of the transfer apparatus 90, the second turntable 10 or the second and optionally third guide track 44, 45 of the second turntable 10 are moved into a state in which the first guide element 24 can be picked up by the second turntable 10. This state for conveying the parts carrier 2 in a straight line across the transfer apparatus 90 differs from the state in which the parts carrier 2 is deflected, in particular by a 90° deflection of the parts carrier 2, due to the fact that the direction of rotation 92 of the second turntable 10 is the same as the direction of rotation of the first turntable 10. The state of the second turntable 10 for conveying the parts carrier in a straight line is again adapted to the desired position of the first guide element 24 and the desired displacement path 13 of the parts carrier 2, speed, acceleration and optionally the change in acceleration of the first guide element 24 over time.

Once the second guide element 26 has been picked up by the first turntable 10 and the first guide element 24 of the parts carrier 2 has been picked up by the second turntable 10, the transfer apparatus 90 and parts carrier 2 are in a state as illustrated in FIG. 6. Accordingly, the first guide element 24 and third guide element 26 of the parts carrier 2 are guided and driven by the first respectively second turntable 10, whilst the second guide element 25 and fourth guide element 27 of the parts carrier 2 are guided along the guide track 5 extending in a straight line between the first conveying section 15 and the third conveying section 91 and optionally by the inner guide tracks 11 und outer guide tracks 12 disposed on the transfer apparatus 90.

Once the third guide element 26 of the parts carrier 2 has left, the parts carrier 2 is driven by the second turntable 10 and first guide element 24, which engages with the guide tracks 44, 45 of the turntable 10. The first guide element 24 of the parts carrier 2 is then driven by the second turntable 10 until the parts carrier 2 is handed over to the subsequent transport module 3 by the feeding device 4, in particular the traction drive 9. Once the first guide element 24 has left the second turntable 10 or operating range of the second turntable 10 and before reaching the third guide element 26 of the second turntable 10 or operating range of the second turntable 10, the second turntable 10 is moved into a transfer position. In this transfer position, the third guide element 26 is moved along the first guide track 43 of the second turntable 10, which preferably lies parallel with a guide track 5 linking the first conveying section 15 and third conveying section 91 in a straight line and linking a first guide track portion 46 to a second guide track portion 47 in a straight line.

To permit rapid cycle times and short intervals between two parts carriers 3, the first turntable 10 can be moved back into a transfer position or pick-up position for another guide element of a subsequent parts carrier whilst the second turntable 10 is disposed in the transfer position. In order to vary the cycle time between the parts carriers 2 and the intervals between two parts carriers 2, the conveying speed of the parts carrier 2 can be reduced or increased when in a position such as that illustrated in FIG. 6a for example, and in particular the parts carrier 2 can be held back in this position for a specific time. This also enables two traction drives or conveyor systems adjoining the transfer apparatus 14, 22, 90 to be uncoupled.

FIGS. 7 and 8 illustrate another embodiment of the transfer apparatus 90 which may optionally be construed as an independent solution in its own right, the same reference numbers and component names being used to denote parts that are the same as those described in connection with FIG. 1 to FIG. 6b above. To avoid unnecessary repetition, reference may be made to the description given with reference to FIG. 1 to FIG. 6b above.

The transfer apparatus 14, 90 illustrated in FIGS. 7 and 8 comprises at least two turntables 10, the stationary guide tracks 5, sensors 21 and optionally recesses 67 for accommodating conveyor systems or feeding devices 4—FIG. 1—of preceding or subsequent transport modules 3—FIG. 1—in particular the traction drive 9—FIG. 1.

The transfer apparatus 90 illustrated in FIGS. 7 and 8 has a transfer apparatus 22 of a similar design and/or based on the same components as that described in connection with FIGS. 3 and 4.

The transfer apparatus 90 is designed to convey a parts carrier 2—FIG. 1—from a first conveying section 15 to a second conveying section 16 or a third conveying section 91, in particular in a manner similar to that described with reference to FIGS. 5a to 5b respectively FIGS. 6a and 6b. In order to guide and/or transmit driving force to a parts carrier 2—FIG. 1—the transfer apparatus 19, in particular the turntables 10 disposed on the transfer apparatus 90, are mounted with stationary or displaceable guide tracks 5. The guide tracks 5 have guide surfaces which complement guide elements 7—FIGS. 9a, b—in particular guide rollers—FIGS. 9a, b. The cross-section of the guide surfaces is approximately V-shaped, for example, or alternatively elliptical or semi-spherical. The parts carrier 2—FIGS. 9a, b—is guided without any clearance or virtually without any clearance, for example with a clearance between the guide roller 8 and guide track 5 or guide surface 93 in the order of approximately 0.05 mm to 1 mm, in particular ca. 0.1 mm.

The guide tracks 5, in particular the guide tracks 5 fixedly disposed on the transfer apparatus 90, are disposed on straight guide track elements 74 and curved elements 60, 61 for example. In regions where other transport modules 3 adjoin the transfer apparatus 90, for example in the region of a first conveying section 15, second conveying section 16 and/or a third conveying section 91, guide track elements 74 are provided, which overlap the two transport modules 3—FIG. 1—in particular the transfer apparatus 90 and an adjoining transport module 3. Due to this overlap of these guide track elements 74, two transport modules 3 can be connected to one another, thereby enabling the guide transitions between the transport modules to be improved.

The turntables 10 of the transfer apparatus 90 preferably have a first guide track 43, a second guide track 44 and/or a third guide track 45, designed to guide and/or transmit driving force to a guide element 7. The layout of the guide tracks 5 and guide tracks 43, 44, 45 on the turntable 10 is similar to the layout of the guide tracks 5 and guide tracks 43, 44, 45 on the turntable 10 of the embodiment described in connection with FIG. 3.

Bridging elements 72 are provided as described with reference to FIG. 3 in particular, preferably just above the turntable 10 of the transfer apparatus 90, which are connected to the transfer apparatus 91, in particular by a screw connection. The bridging element 72 may incorporate the recess 73, in particular a groove or bore, which constitutes a window for a light barrier sensor for detecting the means 68 in order to determine a reference position of the turntable 10. It would also be possible to provide another and/or different device for determining a reference position of the turntable 10 on the bridging element 72 and/or on the transfer apparatus 90. For example, this device for determining a reference position of the turntable 10 might be provided in the form of an inductive sensor which is able to detect a magnet integrated in the turntable, an integrated ferromagnetic element, a raised area or recess, in particular a recess in the turntable.

In order to determine the position or a motion status of the parts carrier 2—FIGS. 9a, b—or guide elements 24, 25, 26, 27—FIG. 5a—of the parts carrier 2, sensors 21, 70, 71 are disposed on the mounting element 75 along the guide tracks 5 and in the first conveying section 15, second conveying section 16 and/or third conveying section 91. The sensors 70 are therefore able to detect if and when the parts carrier 2 has reached or left the transfer apparatus 90. The sensors 70 are preferably disposed in a region adjoining other transport modules 3—FIG. 1. The sensors 70 are designed to determine the position and/or detect the presence of the parts carrier 2 and/or detect a motion status of the parts carrier 2, for example the position, speed, acceleration and/or change in acceleration over time. The detection range of the sensor 70 is between 2 mm and 30 mm, for example. The sensors 70 are connected to the process management system and can prompt a sequence controller when a routine for the transfer operation has to be activated or initiated.

To enable the position of the parts carrier 2—FIG. 1—to be changed more exactly, sensors 71 are disposed along the guide tracks 5, which are configured to detect the guide elements 7 of the parts carrier 2, The sensors 71, which take measurements on an inductive basis in particular, may be used to determine the position of the parts carrier 2 more accurately. Due to the shorter distances between the sensors 71 and guide elements 7—FIGS. 9a, b—of the parts carrier 2 which can be detected by the sensors 71, the sensors 71 have a measuring range of between 0.1 mm and ca. 5 mm. To improve control, the signals from the sensors 70, 71 are transmitted to the controller and in particular to a programmable logic of the controller and processed in it.

To assist with mounting the sensors 21 and to make maintenance easier, the sensors 21 are preferably mounted on a retaining element 94 by a connecting mechanism, in particular are secured to the retaining element 74 by a screw connection. The sensors 21 may also be secured to the retaining element 74 by a bonded connection. The retaining element 94 in turn has a connecting mechanism 95, by means of which the retaining element 94 is connected to the mounting element 75. The connecting mechanism 95 is provided in the form of one or two screws, for example. The connecting mechanism 95 may also be a snap-fit connection. The retaining element 94 for a sensor 21 together with the mounting element 75 and/or sensor 21 preferably forms an at least approximately flat surface. It would also be possible to provide retaining elements 94 on the transfer apparatus 90 or on the mounting element 75, which cover a recess for a sensor 21. At points where a recess for a sensor 21 is provided on mounting elements 75, the sensor 21 need not necessarily be provided for the controller and this recess can therefore be covered.

FIG. 8 is a perspective view of the transfer apparatus 90 illustrated in FIG. 7. Here, the connecting mechanism 77, in particular the groove 78, may be seen, by means of which the transfer apparatus 90 can be connected to other transfer apparatuses 14 and/or transport modules 3 and/or a support frame for transport modules 3. The groove 78 is preferably a T-shaped groove extending parallel with the transport plane 20. The connecting mechanism 77 may also have a centring element in a transition region to a transport module 3—FIG. 1—adjoining the transfer apparatus 90, for example centring bores or locating holes for locating pins or other fixing means, for example a thread or other T-shaped grooves.

Also illustrated in FIG. 8 are the drive devices 76, provided in the form of electric motors 79, in particular servo-motors 80, for example. The drive devices 76 may also be provided in the form of geared motors, for example.

FIG. 9a and FIG. 9b illustrate the parts carrier 2 which, on its bottom face, in other words the face directed towards the guide tracks 5; 11, 12; 43, 44, 45 or transfer apparatus 14; 22, has guide elements 7 with a groove-shaped recess 81 on the external circumference to provide vertical and/or lateral guidance. These guide elements 7 may be provided in the form of rotating guide rollers 82, for example, mounted by means of shafts 82 oriented perpendicularly to a transport plane 20—FIG. 1—and rotating thereon. The groove-shaped recess 81 of the guide elements 7 preferably complements a V-shaped cross-section of the guide tracks 5; 11, 12; 43, 44, 45.

The guide elements 7 are disposed on oppositely lying sides of the parts carrier 2 in corner regions respectively, and the guide elements 7 co-operate with the guide tracks 5, 11, 12 disposed there, at least in the region of conveying sections 15, 16. The parts carrier 2 is preferably of a square shape and the guide elements 7 or the guide rollers 83 constituting them are disposed on a bottom face 84 of the parts carrier 2 directed towards the transport plane 20.

It is also of advantage if the parts carrier 2 has at least one orifice 34 extending in the vertical direction by reference to the transport plane 20, and this orifice 85 is preferably disposed at the centre of the parts carrier 2. Alternatively, not only would it be possible to provide the orifice 85 at the centre of the parts carrier 2, several of them may also be provided in the region of diagonals of the parts carrier 2. It would also be conceivable to opt for a combination of these layouts.

The parts carrier 2 also has locating elements 86, arranged in a cross shape and extending through the centre. The locating elements 86, similar to toothed racks, can be moved so that they locate in a feeding device 4, in particular a traction drive 9.

In order to obtain a more reliable feeding movement and hence a clear motion sequence of the parts carrier 2, the guide tracks 5 of the transfer apparatus 14, 22 locate with the respective mutually facing sides of the guide elements 7 of the parts carrier 2, at least in the region of conveying sections 15, 16. Inwardly lying guide tracks 11 for the guide elements 7 of the parts carrier 2 incorporating the groove-shaped recess 8 may be provided on the transfer apparatus 5, 14 for receiving and guiding the parts carrier 2. This being the case, the inwardly lying guide tracks 11 of the transfer apparatus 14, 22 are arranged on it in such a way that they locate with the respective mutually facing sides of the guide elements 7 of the parts carrier 2. This means that the inwardly lying guide tracks 11 are each of a V-shaped design on the sides facing away from one another and in the opposite direction have a converging cross-section. This results in a compact arrangement of the guide tracks 11 on the transfer apparatus.

In order to obtain a friction-free transfer and/or handover of the parts carrier 2 from and to a transport module 3, it is of advantage if the guide tracks 5, 11, 12 extend beyond the end of the first or second conveying sections 15, 16 facing the transfer apparatus 14, 22 in the direction towards the transport module 3 adjoining the transfer apparatus. This ensures that the feeding device 4 is bridged as the parts carrier 2 is conveyed and guarantees the locating action with the locating elements 10 disposed on it.

When the parts carrier 2 is disposed in the region of a work station with its components disposed on it, although these are not illustrated, its own weight and optionally processing forces acting on it are transmitted from the guide elements 7 incorporating the V-shaped recesses 81 to the guide tracks 5. This can cause damage to the bearing arrangement, guide elements 7 and guide tracks 5. For this reason, when the parts carrier 2 is in position on the transfer apparatus 14, 22 or transport module 3 and when the guide elements 7 are engaged with the guide tracks 5 of the transfer apparatus or transport module 3 adjoining it, it can be raised in the direction perpendicular to the transport plane 20 and can be supported on the transfer apparatus 14, 22 in the direction perpendicular to the transport plane 20. To this end, the parts carrier 2 has support parts 87 disposed on certain regions of its bottom face 84, preferably in the region close to the guide elements 7. As may best be seen from FIG. 9a, these support parts 87 are approximately L-shaped and are used to take the weight of vertical loads. To provide a longer and more exact vertical support and reduce wear, the support parts 87 are made from a hard, wear-resistant material, which might be selected from the group comprising hard metal, steel, ceramic, plastic or a combination of these. For example, the support parts 87 may be disposed in the region of diagonals of the parts carrier 2, in which case they are positioned between the guide elements 7 and the centre of the parts carrier 2.

To enable the parts carrier 2 to be used universally and in all travel or feed directions in conjunction with the support parts 87, the latter are approximately L-shaped and thus form support surfaces 87 extending respectively in a cross shape and parallel with one another. Alternatively or in addition, it would also be possible for the parts carrier 2 to be supported on the transfer apparatus 14, 22 by end faces of the shafts 82 of the guide rollers 83. In any case, the entire parts carrier 2 with its guide elements 7 is raised relative to the transfer apparatus 14, 22 until the V-shaped recess 81 on the guide elements 7 are not transmitting load to the guide tracks 5. As a result, higher pressing forces can be transmitted to the parts carrier 2 in the vertical direction, such as occur during welding or processing operations for example, without the guide elements 7 exactly co-operating with the other guide tracks 5 sustaining any damage and without any inaccuracy in terms of positioning.

To enable the individual parts carriers 2 to be uniquely identified as they are moved or fed along the guide tracks 5 and when they are in the individual work stations, the parts carriers 2 are provided with identification means, preferably on their bottom face 84. These may be disposed in the peripheral regions of the parts carrier 2 or its main body extending between the guide rollers 7. These means might be code transmitters, RFID transponders, RFID elements or barcodes, for example. By RFID element (Radio Frequency Identification Element) is meant chip-supported elements which operate without contact, in particular so-called transponder elements. These identification means may be read in every work station, for example, and data may be transmitted to the identification means on completion of a work step or process and stored there as additional information, for example. As a result, therefore, unique information can be retrieved from each one of these parts carriers 2 during all the movements of the parts carrier 2 through the transport system 1. This enables the economics and reliability of the entire transport system to be significantly increased and improved.

FIG. 10 is a detailed diagram illustrating an embodiment of the transfer apparatus 14, 90 which may be construed as an independent solution in its own right. It illustrates a first position 96 and a second position 97 of the turntable 10.

In position 96, the turntable 10 serves as a stop surface 98, disposed in particular on a guide track element 74. The stop surface 98 is used to hold the guide element 7 in the direction of the guide line 30. This enables onward transport of the parts carrier 2—FIG. 1—to be temporarily delayed or prevented.

Position 97 of the turntable 10 indicated by broken lines and the guide tracks 43, 44, 45 disposed on the turntable 10 indicate a pick-up position or transfer position for example, in which the guide element 7 is picked up from the guide tracks 5 on the guide tracks 43, 44, 45 fixedly joined to the turntable and connected to the transfer apparatus 14, 90 and discharged onto the guide tracks 4 fixedly connected to the transfer apparatus 14, 90. During this procedure, the turntable 10 and the guide tracks 44, 45 connected to the turntable 10 are controlled or rotated so that the guide line 48 rotating in unison with the turntable points in the direction of the mid-point 29 of the guide element 7 and in the direction of the pivot axis 34 of the guide element 7 as the guide element 7 is being picked up and transferred. The turntable 10 and the guide tracks 44, 45 rotating in unison with the turntable, which guide the guide element 7 or its mid-point 29 along the guide line 48 rotating in unison with the turntable as viewed by an observer in a stationary position on the turntable, is controlled and driven so that the angular position of the turntable 10 and the guide tracks 44, 45 rotating in unison with the turntable, angular speed, angular acceleration and optionally the change in angular acceleration match the position, speed, acceleration and optionally change in acceleration of the guide element 7, thereby ensuring a jolt-free pick-up and transfer of the guide element 7 by the turntable 10. In order to adapt the motion status of the turntable 10 to the parts carrier 2 and to the guide element 7, the motion status of the turntable 10 is synchronised with a motion status of another or different feeding device 4 driving and guiding the parts carrier 2—FIG. 1—and/or the motion status of the parts carrier 2—FIG. 1—is determined by means of measurement signals from sensors 21—FIG. 1. In order to match the motion status of the turntable 10 with that of the parts carrier 2—FIG. 1—or to match that of the turntable 10 with one or more other feeding devices 4—FIG. 1—in particular one or more turntables 10, a synchronisation table may be stored in a memory device of a controller, for example, by means of which a motion status or control signal for activating the turntable 10 can be assigned to each motion status of the parts carrier 2—FIG. 1—or one or more other feeding devices 4—FIG. 1.

FIG. 11 illustrates another embodiment of a turntable 10 which may be construed as an independent solution in its own right. The same reference numbers and component names are used to denote parts that are the same as those described with reference to the drawings above. To avoid unnecessary repetition, reference may be made to the detailed description of the drawings given above.

The embodiment of the turntable 10 illustrated in FIG. 11 has curved guide tracks 44, 45. By means of the curved guide track 44 and/or the curved guide track 45, the guide element 7—FIG. 1—of the parts carrier 2—FIG. 1—is guided along guide line 48 from the point of view of an observer in a stationary position on the turntable. The guide line 48 also extends in a curve. The curvature of the guide track 44 and/or guide track 45 at one point or one position of the guide track 44, 45 may be selected as a function of the distance of the point or position of the guide track 44, 45 from the pivot axis 19 of the turntable 10. For example, the curvature becomes more or less pronounced, the greater the distance of the point of the guide track 44, 45 is from the pivot axis 19. By preference, the curvature increases monotonously or decreases monotonously from one end 50 of the guide track 44, 45 to a minimum distance of the guide track 44, 45 from the pivot axis 19 of the turntable. The curvature may also have a point at which it is zero or assumes a value 0 at one point. For example, the curvature has a negative value at one end 50 and increases to a positive value at a point of minimum distance of the guide track 44, 45 from the pivot axis 19. By curvature of the guide track 44, 45 is meant the change in direction per unit of length. For example, the curvature has a value of between 1 and 50 per metre or between −1 and −50 per metre at one end 50 of the guide track 44, 45.

The contour of the guide track 44, 45 is selected so that a pre-defined speed curve or curve of the motion status of the parts carrier 2 driven or conveyed by the guide track 44, 45 of the turntable 10 is obtained at a constant angular speed or rotation speed of the turntable 10. The contour of the guide track 44, 45 or curvature of the guide track 44, 45 is selected so that the parts carrier 2—FIG. 1—or one of the guide elements 7—FIG. 1—of the parts carrier 2 is driven by means of the turntable 10 or the guide tracks 44, 45.

FIG. 12 illustrates another embodiment of a transfer apparatus 14 which may be construed as an independent solution in its own right, the same reference numbers and component names again being used to denote parts that are the same as those described in connection with the drawings above. To avoid unnecessary repetition, reference may be made to the detailed description given with reference to FIGS. 1 to 11 above.

The turntable 10 illustrated in FIG. 12 has a displaceable guide track 99 and a displaceable guide track element 100. The guide track element 100 is preferably displaceable in a direction parallel with the guide line 48 rotating in unison with the turntable. The movement of the displaceable guide track element 100 or displaceable guide track 99 relative to the turntable may be influenced by means of a spring 101 and/or an actuator drive and/or a guide element 7—FIG. 9a—or the parts carrier 2—FIG. 9a. The guide track 99 displaceable relative to the turntable 10 disposed on the displaceable guide track element 100 may be disposed parallel with or at an angle to the direction of movement of the displaceable guide track element 100 or guide line 48, preferably within an angle of between 45° and 135°, in particular by approximately 90°. The displaceable guide track element 100 is preferably guided along a linear guide, for example along a V-shaped or T-shaped guide groove, by means of a slide bearing or a ball or roller bearing. In another embodiment, the displaceable guide track element 100 is pivoted on the turntable 10 about a pivot axis.

It would also be possible to provide several guide tracks 99 on the guide track element 100, preferably disposed at an angle to one another, and the guide track 99 may also extend in a curve.

The embodiment of a turntable 10 schematically illustrated in FIG. 13 has an approximately V-shaped guide track element 102, which is linearly guided on the turntable 10 by means of a guide device 103. A force, for example a spring force and/or a damping force, acts on the guide track element 102 by means of a device 104, for example a spring device 105, at least in certain portions and/or at certain times.

The device 104 for applying force to the guide track element 102 comprises a spring element 106 and/or a damping element and/or a drive device, for example an electric or pneumatic linear drive. The device 104 or spring element 106 applies force to the guide track element 102 acting in a radial direction of the turntable 10, as a result of which the guide elements 7 of the parts carrier 2—FIGS. 9a,b—are forced along a defined guide track 5 of the transfer apparatus 14, thereby minimising a guide clearance. This results in an at least approximately clearance-free and defined position of the parts carrier 2.

The guide track element 102 has guide tracks 44, 45 disposed approximately in a V-shape, which accommodate the guide element 7 of the parts carrier 2. The guide tracks 44, 45 of the guide track element 102 optionally have rounded regions 108 in their end regions 107, in order to facilitate and improve the process of picking up and depositing the guide element 7 by means of the guide tracks 44, 45 of the turntable 10.

To avoid a pointed contact point between the guide element 7 and guide track element 102, the guide track element 102 has rounded regions 109 and the guide tracks 44, 45 may have a rounded region 109. The rounded regions 109 have a radius that is more or less adapted to the guide element 7. Whilst the guide element 7 is being picked up by the guide element 102 and whilst the guide element 7 is lying on the guide tracks 44, 45, no relative movement takes place between the guide element 7 and the guide element 102 and guide tracks 44, 45, thereby reducing wear on the guide element and/or guide track element 102.

In order to guide the guide track element 102 linearly on the turntable 10, it is fitted with or connected to the guide device 103. The guide device 103 has one or more, for example two, guide tracks 110, 111 disposed on the guide track element 102 and on the turntable 10. The guide tracks 110, 111 are disposed parallel with the plane of the turntable 10 in order to guide the guide track element 102 in a direction approximately perpendicular to the pivot axis of the turntable 10, in particular in a radial direction. The guide tracks 111 on the turntable 10 have V-shaped grooves for example, in which the guide tracks 110 of the guide track element 102 locate. To enable wear between the guide tracks 110, 111 to be reduced, sliding or roller elements are provided, for example an anti-friction coating, an anti-fiction element made from plastic or metal or spheres.

FIG. 14 illustrates another embodiment of a turntable 10 with displaceably mounted guide tracks 44, 45, 112 and guide track elements 113 which may be construed as an independent solution in its own right.

The guide track elements 113 and the guide tracks 44, 45, 112 disposed on the guide track elements 113 are arranged in a U-shape so that they are designed to accommodate a guide element 7—FIGS. 9a,b—of the parts carrier 2—FIGS. 9a,b. The U-shape is formed by the guide track 112 extending perpendicular to the direction of movement of the U-shaped guide track arrangement 114 and by the mutually parallel guide tracks 43, 45 extending essentially at a right angle to the guide track 112. The guide tracks 44, 45 are disposed at a distance approximately corresponding to the diameter 39 of a guide element 7.

The guide track arrangement 114 and the guide track elements 113 are disposed on a displaceably mounted base plate 115 and secured by means of a screw connection for example. The guide tracks 44, 45, 112 may be of an integral design with the base plate 115.

The base plate 115 is connected to a guide device 103 or mounted or secured on it, by means of which the base plate 115 and hence the guide tracks 44, 45, 112 are mounted so that they can be linearly displaced on the turntable 10. The guide tracks 44, 45, 112 are mounted by means of the guide device 103 so as to move in a plane lying perpendicular to the pivot axis 19 and in a plane lying parallel with the transport plane 20, in particular linearly.

The guide device 103 has a guide carriage 116 connected to the base plate 115 and a guide rail 117 connected to the turntable 10 on which the guide carriage is guided. The guide device 103 is based on a design known per se and the guide device is provided in the form of a ball or roller mounted linear guide.

The base plate 115 and guide tracks 44, 45, 112 are connected to a device 104 for applying a force to the base plate and guide tracks 44, 45, 112. The applied force may be a spring force, driving force and/or damping force. The device 104 preferably has spring elements 106, in particular compression springs, which push the base plate 115 and guide track arrangement 114 on the turntable 10 radially outwards and against the guide element 7.

The guide track arrangement 114 is preferably displaceable in a direction parallel with the guide line 48 rotating in unison with the turntable—FIG. 13. The movement of the displaceable guide track arrangement 114 relative to the turntable 10 is influenced by the device 104 and/or an actuator drive and/or a guide element 7.

In another embodiment, the guide track arrangement 114 displaceable relative to the turntable 10 is disposed so that it can be pivoted on the turntable 10 about a pivot axis. The spring device 105 used for this purpose may be a rotary spring.

One or more guide track arrangements 114, in particular two as illustrated in FIG. 14, may be provided on the turntable 10, laid out radially or in a star shape or lying opposite one another. The spring device 105 or spring elements 106 act between the base plates 115 or respectively between a U-shaped or V-shaped base plate 115 fitted with a guide track arrangement 114, base plate 115 and turntable 10.

The turntable 10 is connected to a drive device 76. Disposed between the drive device 76 and the turntable is a coupling mechanism 117, by means of which the centring of the pivot axis 19 of the turntable and the pivot axis of the drive device 76 can be adjusted. To this end, the coupling mechanism 117 has one or two displacement mechanisms disposed at an angle to one another and at least two coupling portions which can be displaced relative to one another by means of the displacement mechanism, enabling the turntable 10 to be moved relative to the drive device 76 in at least two directions, for example in two directions extending perpendicular to one another and/or perpendicular to the pivot axis.

The embodiments illustrated as examples represent possible variants of the transport system, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the transport system, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1a, 1b; 2a, 2b, 2c, 2d, 2e; 3, 4; 5a, 5b, 5c, 5d; 6a, 6b; 7, 8; 9a, 9b; 10; 11; 12; 13; 14 constitute independent solutions proposed by the invention in their own right. The objectives and associated solutions proposed by the invention may be found in the detailed descriptions of these drawings.

List of reference numbers

| | |
|---|---|
| 1 | Transport system |
| 2 | Parts carrier |
| 3 | Transport module |
| 4 | Feeding device |
| 5 | Guide track |
| 6 | Direction of movement |
| 7 | Guide element |
| 8 | Guide rollers |
| 9 | Traction drive |
| 10 | Turntable |
| 11 | Guide track |
| 12 | Guide track |
| 13 | Displacement path |
| 14 | Transfer apparatus |
| 15 | Conveying section |
| 16 | Conveying section |
| 17 | Transfer means |
| 18 | Guide track |
| 19 | Pivot axis |
| 20 | Transport plane |
| 21 | Sensor |
| 22 | Transfer apparatus |
| 23 | Orientation |
| 24 | Guide element |
| 25 | Guide element |
| 26 | Guide element |
| 27 | Guide element |
| 28 | Point |
| 29 | Mid-point |
| 30 | Guide line |
| 31 | Guide line |
| 32 | Guide line |
| 33 | Guide line |
| 34 | Pivot axis |
| 35 | Angle of symmetry |
| 36 | Section |
| 37 | Section |
| 38 | Distance |
| 39 | Diameter |
| 40 | Diameter |
| 41 | Gap |
| 42 | Distance |
| 43 | Guide track |
| 44 | Guide track |
| 45 | Guide track |
| 46 | Guide track portion |
| 47 | Guide track portion |
| 48 | Guide line |
| 49 | Guide line |
| 50 | End |
| 51 | Region |
| 52 | Region |
| 53 | Region |
| 54 | Region |
| 55 | Guide line curve |
| 56 | Guide line curve |
| 57 | Guide line curve |
| 58 | Guide line curve |
| 59 | Radius |
| 60 | Curved element |
| 61 | Curved element |
| 62 | Intersection |
| 63 | Guide track curve |
| 64 | Guide track curve |
| 65 | Radius |
| 66 | Radius |
| 67 | Recess |
| 68 | Means |
| 69 | Bore |
| 70 | Sensor |
| 71 | Sensor |
| 72 | Bridging element |
| 73 | Recess |
| 74 | Guide track element |
| 75 | Mounting element |
| 76 | Drive device |
| 77 | Connecting mechanism |
| 78 | Groove |
| 79 | Electric motor |
| 80 | Servo-motor |
| 81 | Recess |
| 82 | Shafts |
| 83 | Guide rollers |
| 84 | Bottom face |
| 85 | Orifice |
| 86 | Locating element |
| 87 | Support part |
| 88 | Support surface |
| 89 | |
| 90 | Transfer apparatus |
| 91 | Conveying section |
| 92 | Direction of rotation |
| 93 | Guide surface |
| 94 | Retaining element |
| 95 | Connecting mechanism |
| 96 | Position |
| 97 | Position |
| 98 | Stop surface |
| 99 | Guide track |
| 100 | Guide track element |
| 101 | Spring |
| 102 | Guide track element |
| 103 | Guide device |
| 104 | Device |
| 105 | Spring device |
| 106 | Spring element |
| 107 | End region |
| 108 | Rounded region |
| 109 | Rounded region |
| 110 | Guide track |
| 111 | Guide track |
| 112 | Guide track |
| 113 | Guide track element |
| 114 | Guide track arrangement |
| 115 | Base plate |
| 116 | Guide carriage |
| 117 | Coupling mechanism |

1. A turntable with a transfer means for guiding a parts carrier which can be displaced along guide tracks between a first conveying section and a second conveying section by means of guide elements, and the transfer means can be pivoted about a pivot axis oriented perpendicular to a transport plane and has at least one guide track along which the parts carrier is guided by at least one of the guide elements, wherein the turntable is coupled with a drive means connected to a control unit for transmitting a driving force from the transfer means to the parts carrier.

2. The turntable as claimed in claim 1, wherein the guide track of the transfer means extends in a straight line.

3. The turntable as claimed in claim 1, wherein the transfer means has a second guide track disposed at an angle to the first guide track.

4. The turntable as claimed in claim 3, wherein the transfer means has a third guide track disposed at a distance from at least one diameter of one of the guide elements parallel with the first guide track or second guide track.

5. The turntable as claimed in claim 4, wherein a distance of one end of the first guide track of the transfer means from one end of the second and/or third guide track or from a second end of the first guide track is shorter than a distance between two guide elements of the parts carrier, in particular by at least the diameter of one of the guide elements.

6. The turntable as claimed in claim 1, wherein the guide track extends in a curve.

7. The turntable as claimed in claim 1, wherein the guide track has a curvature including contour which increases monotonously or decreases monotonously, the greater the distance of the guide track is from the pivot axis.

8. The turntable as claimed in claim 1, wherein one of the guide tracks of the transfer means is mounted so as to be displaceable relative to another guide track of the transfer means.

9. The turntable as claimed in claim 1, wherein at least one guide track arrangement with an approximately V-shaped or U-shaped crosssection, in particular guide tracks disposed more or less in a V-shape or U-shape, are mounted on the turntable so that they are able to move.

10. The turntable as claimed in claim 9, wherein the guide track arrangement disposed more or less in a V-shape or U-shape, in particular the guide tracks disposed in an approximately V-shaped or U-shaped arrangement, is mounted so as to be resiliently elastic and/or provide a damping action, at least in one direction.

11. A Transfer apparatus with a feeding device comprising at least one turntable for guiding a parts carrier which can be displaced along guide tracks between a first conveying section and a second conveying section, and the turntable can be pivoted about a pivot axis oriented perpendicular to a transport plane, wherein the turntable is as claimed in one of claim 1.

12. The transfer apparatus as claimed in claim 11, wherein the guide tracks are mounted so as to guide the guide elements of the parts carrier along guide lines and/or to guide a central point of the parts carrier along a displacement path.

13. The transfer apparatus as claimed in claim 11, wherein guide tracks for guiding the parts carrier that are stationary relative to the turntable are disposed parallel with the transport plane.

14. The transfer apparatus as claimed in claim 11, wherein at least one guide track is disposed on the turntable, which is designed to guide a guide element of the parts carrier along an imaginary guide line whilst the turntable is stationary.

15. The transfer apparatus as claimed of claim 11, wherein at least one guide track is disposed on the turntable which subtends an angle with an instantaneous direction of movement of the guide element when co-operating with a guide element of the parts carrier.

16. The transfer apparatus as claimed in claim 11, wherein a drive device is connected to the turntable.

17. The transfer apparatus as claimed in claim 16, wherein the drive device is provided in the form of an electrically operated motor, in particular a servo-motor.

18. The transfer apparatus as claimed in claim 16, wherein the drive device is designed to position the turntable at an angle.

19. The transfer apparatus as claimed in claim 11, wherein the feeding device comprises a traction drive, in particular a toothed belt drive.

20. The transfer apparatus as claimed in claim 19, wherein the turntable is mechanically connected to the traction drive.

21. The transfer apparatus as claimed in claim 19, wherein a drive device for the traction drive provided separately from the drive device of the turntable is connected to the traction drive.

22. The transfer apparatus as claimed in claim 11, wherein the parts carrier can be moved from a pick-up position into a transfer position by means of the turntable.

23. The transfer apparatus as claimed in claim 22, wherein the parts carrier can be moved into specific positions in the transport plane between the pick-up position and transfer position by the arrangement comprising the turntable and/or guide tracks as a function of the position of the turntable.

24. The transfer apparatus as claimed in claim 1, wherein the pivot axis of the turntable lies on an angle of symmetry of two straight sections of guide lines or the displacement path and extends approximately perpendicular to it.

25. The transfer apparatus as claimed in claim 11, wherein the pivot axis of the turntable, in particular a turntable with a curved guide track, is disposed between two parallel stationary guide tracks.

26. The transfer apparatus as claimed in claim 11, wherein the pivot axis of the turntable, in particular a turntable with a guide track extending in a straight line, is disposed outside two parallel guide tracks.

27. The transfer apparatus as claimed in claim 11, wherein an at least approximately flat surface is disposed between the parallel guide tracks.

28. The transfer apparatus as claimed in claim 27, wherein the guide tracks are of a height of at most 5 mm above the surface.

29. The transfer apparatus as claimed in claim 11, wherein two parallel guide tracks, in particular for one of the guide elements, are disposed in a region where of one of the guide elements is transferred from a stationary guide track to a guide track of the turntable or where one of the guide elements is transferred from a guide track of the turntable to the stationary guide track.

30. The transfer apparatus as claimed in claim 11, wherein two parallel guide tracks for one of the guide elements, in particular an inner guide track curve and/or an outer guide track curve, are disposed in a region of a guide line curve.

31. The transfer apparatus as claimed in claim 11, wherein a guide track of a guide track curve is provided in the form of a curve, the radius of which is bigger at the curve beginning and/or curve end than in a section lying between the curve beginning and curve end.

32. The transfer apparatus as claimed in claim 11, wherein a radius of the guide line is bigger than half the diameter of the guide element.

33. The transfer apparatus as claimed in claim 11, wherein the feeding device has another turntable as claimed in claim 1.

34. The transfer apparatus as claimed in claim 11, wherein the feeding device has at least two other turntables as claimed in claim 1.

35. The transfer apparatus as claimed in claim 11, wherein a region across which at least one of the guide tracks of the turntable is able to pass forms a movement region and at least one branch of the guide line for changing orientation and/or for changing the direction of movement lies within the movement region of the guide tracks of the turntable.

36. The transfer apparatus as claimed in claim 11, wherein, based on the disposition of the turntable and/or guide tracks, a branch of the displacement path for changing the orientation lies before a branch for changing the direction of movement as viewed in the direction of movement of the parts carrier.

37. The transport system with a first conveying section and a second conveying section and a transfer apparatus disposed between them, wherein the transfer apparatus is as claimed in claim 11.

38. The transport system as claimed in claim 37, wherein another conveying section is disposed on the transfer apparatus.

39. The transport system as claimed in claim 37, wherein another transfer apparatus disposed on the transfer apparatus.

40. A method of handling parts carriers with a transfer apparatus comprising at least one turntable for guiding a parts carrier which can be displaced along guide tracks between a first conveying section and a second conveying section by means of guide elements, and the turntable has at least one guide track and can be pivoted about a pivot axis oriented perpendicular to a transport plane wherein, comprising the methods steps of:
moving a guide track into a first pick-up position, picking up a first guide element of the parts carrier, conveying the parts carrier by means of a feeding device, rotating the guide track into a second pick-up position for picking up a second guide element of the parts carrier, rotating the guide track as far as a transfer position, conveying the parts carrier by means of a feeding device until the parts carrier leaving the transfer apparatus, wherein a driving force is applied to the parts carrier by a guide track of the turntable between the pick-up position and transfer position.

41. The handling method as claimed in claim 40, wherein at least one of the guide elements of the parts carrier is guided on two sides in directions perpendicular to the guide track and parallel with the transport plane, at least in a region where one of the guide elements is transferred from a stationary guide track to a guide track of the turntable or where one of the guide elements is transferred from a guide track of the turntable to the stationary guide track.

42. The handling method as claimed in claim 40, wherein, in the pick-up position and in the transfer position, the parts carrier moves between the guide tracks disposed in a stationary arrangement with respect to the transfer apparatus and the displaceable guide tracks co-operating with the turntable.

43. The handling method as claimed in claim 40, wherein the parts carrier is moved by means of at least one of the guide tracks co-operating with the turntable when the parts carrier is moved between the pick-up position and the transfer position.

44. The handling method as claimed in claim 40, wherein the turntable is pivoted about the pivot axis of the turntable at a constant pivot speed.

45. The handling method as claimed in claim 40, wherein the turntable is moved on the basis of a preferably automatically controlled speed curve, whereby the parts carrier is moved at a uniform, in particular constant, speed.

46. The handling method as claimed in claim 40, wherein the direction of movement of the parts carrier is changed by the transfer apparatus, in particular by 90°.

47. The handling method as claimed in claim 40, wherein the orientation or position of the parts carrier is changed by the transfer apparatus, in particular by 90° or 180°.

48. The handling method as claimed in claim 40, wherein before and/or after a change in the direction of movement, the orientation or position of the parts carrier is changed by the transfer apparatus, in particular by 90° or 180°

49. The method of controlling a transfer apparatus for a parts carrier as claimed in claim 11, incorporating the method step of:
transmitting control data for rotating a turntable into a pick-up position in which a guide element is transferred from a stationary guide track to at least one guide track of the turntable.

50. The method as claimed in claim 49, wherein control data is transmitted in order to rotate the turntable into a transfer position.

51. The method as claimed in claim 49, wherein control data for controlling several turntables disposed on a transfer apparatus is synchronised on the basis of a synchronisation table.

52. The method as claimed in claim 49, wherein before and/or during and/or after conveying the parts carrier by means of the turntable, a signal is read from a sensor.

53. The method as claimed in claim 49, wherein the control data is compiled as a function of a measured angular position of at least one turntable and/or a position and/or disposition of the parts carrier.

54. A data carrier wherein it is used to store a program for implementing a method as claimed in claim 40 and/or a method as claimed in claim 49.
